(19) United States
(12) Patent Application Publication
(10) Pub. No.: US 2022/0410898 A1
(43) Pub. Date: Dec. 29, 2022

(54) AUTONOMOUS TRAILER MANEUVERING

(71) Applicant: Outrider Technologies, Inc., Golden, CO (US)

(72) Inventors: Jeremy Nett, Golden, CO (US); Ky Woodard, Golden, CO (US); Michael Cutter, Golden, CO (US); James Bailey, Golden, CO (US); Matt Brekken, Golden, CO (US); Yu-Cheng Lin, Golden, CO (US); Lawrence Klein, Bend, OR (US)

(21) Appl. No.: 17/848,123

(22) Filed: Jun. 23, 2022

Related U.S. Application Data
(60) Provisional application No. 63/214,229, filed on Jun. 23, 2021.

(51) Int. Cl. B60W 30/18; B60W 60/00

(52) U.S. Cl. CPC B60W 30/18036; B60W 60/0025; B60W 2300/145; B60W 2420/42; B60W 2420/52; B60W 2556/45; B60W 2530/201

(57) ABSTRACT

In embodiments, a method positions and aligns an autonomous tractor coupling with an articulated trailer located in a pick-up spot. A staging path that terminates at a staging point corresponding to the pick-up spot is determined, and the tractor is controlled to follow the staging path to the staging point and then couple with the trailer. In embodiments, a method positions and aligns an autonomous tractor coupled to an articulated trailer in preparation for the tractor to reverse the trailer into a drop-off spot. A staging path having a shape and a staging point is determined, and the autonomous tractor is controlled to follow the staging path to the staging point. The staging path is shaped such that, after following the staging path to the staging point, the tractor and trailer are positioned for reversing into the drop-off spot.

### RELATED APPLICATION

This Patent Application claims priority to U.S. Provisional Patent Application No. 63/214,229, filed on Jun. 23, 2021, which is incorporated herein by reference in its entirety.

### BACKGROUND

Trucks are an essential part of modern commerce. These trucks transport materials and finished goods across the continent within their large interior spaces. Such goods are loaded and unloaded at various facilities that can include manufacturers, ports, distributors, retailers, and end users. Large over-the road (OTR) trucks typically consist of a tractor or cab unit and a separate detachable trailer that is interconnected removably to the cab via a hitching system that consists of a so-called fifth wheel and a kingpin.

Further challenges in trucking relate to docking, loading and unloading of goods to and from trailers. Warehouses and good distribution facilities have yards with multiple loading docks, and the trailer is positioned at one of the loading docks for loading and unloading.

### SUMMARY

In an automated yard, the OTR truck stops at a designated location in staging area of the yard, and the OTR tractor detaches, leaving the trailer at the designated location (e.g., a parking spot) in a staging area of the autonomous yard. An autonomous tractor moves the trailer from the staging area to a first one of the loading docks for unloading and/or loading. Another, or the same, autonomous tractor moves the trailer away from the loading dock when loading and/or unloading is complete and parks the trailer in a designated location of the staging area. The trailer may also be moved between loading docks if needed by another, or the same, autonomous tractor. Another, or the same, OTR tractor couples with the trailer in the staging area and departs the yard with the trailer for another destination.

In some embodiments, a method for positioning and aligning an autonomous tractor in preparation for the tractor to couple with an articulated trailer located in a pick-up spot includes determining a current location and orientation of the tractor; determining, based on the current location and a location of the pick-up spot, a staging path that terminates at a staging point corresponding to the pick-up spot; and controlling the tractor to follow the staging path to the staging point.

In some embodiments, a method for positioning and aligning an autonomous tractor coupled to an articulated trailer in preparation for the tractor to reverse the trailer into a drop-off spot includes determining a current location and a current orientation of the tractor and the trailer; determining, based on the current location, a staging path having a shape and a staging point at an end of the staging path; controlling the tractor to follow the staging path to the staging point; and wherein the staging path is shaped such that, after following the staging path to the staging point, the tractor and trailer are positioned for reversing into the drop-off spot.

### BRIEF DESCRIPTION OF THE FIGURES

FIG. 1 is an aerial view showing one example autonomous yard that uses an autonomous tractor to move trailers between a staging area and loading docks of a warehouse, in embodiments.

FIG. 2 is a block diagram illustrating key functional components of the autonomous tractor of FIG. 1, in embodiments.

FIG. 3 is a side elevation showing the tractor of FIG. 1 reversing under a lower surface of a trailer, in embodiments.

FIG. 4 shows one example hitch and unhitch sequence of states implemented by the function state machine of FIG. 2 for coupling and uncoupling the tractor and the trailer, in embodiments.

FIG. 5 shows the maneuvering module of FIG. 2 in further example detail, in embodiments.

FIGS. 6A and 6B are schematic plan views illustrating one example mission for tractor 104 to collect the trailer from a pick-up spot and to a deposit the trailer in a drop-off spot, in embodiments.

FIG. 6C shows an alternative positioning of the tractor and the trailer in preparation for reversing the trailer into the drop-off spot of FIG. 6B, in embodiments.

FIGS. 7A and 7B are flowcharts illustrating one example method for pick-up of a trailer from a pick-up spot, in embodiments.

FIGS. 8A and 8B are flowcharts illustrating one example method for backing a trailer into a drop-off spot, in embodiments.

FIG. 9 is a flowchart illustrating one example method for depositing a trailer at a drop-off spot, in embodiments.

FIGS. 10A-10D are schematic plan diagrams illustrating how the staging path of FIG. 6B is determined based on a position and orientation of the tractor and the trailer relative to the designated drop-off spot, in embodiments.

FIG. 11 is a front view of a loading dock with two fiducial markers positioned above a loading door, and one fiducial marker positioned between adjacent loading docks, in embodiments.

FIG. 12 is a perspective view showing the tractor of FIG. 1 reversing the trailer into the loading dock of FIG. 11, in embodiments.

FIG. 13 shows one example image captured by a camera of the tractor as the trailer nears the loading door of FIG. 11, in embodiments.

FIG. 14 is a front view of a loading dock with two Light Detection and Ranging (LIDAR) poles positioned adjacent a loading door, in embodiments.

### DETAILED DESCRIPTION OF THE EMBODIMENTS

In an automated yard, an autonomous tractor moves trailers between staging areas and loading docks for unloading and/or loading. The autonomous tractor repeatedly couples (hitches) to a trailer, moves the trailer, and then decouples (unhitches) from the trailer.

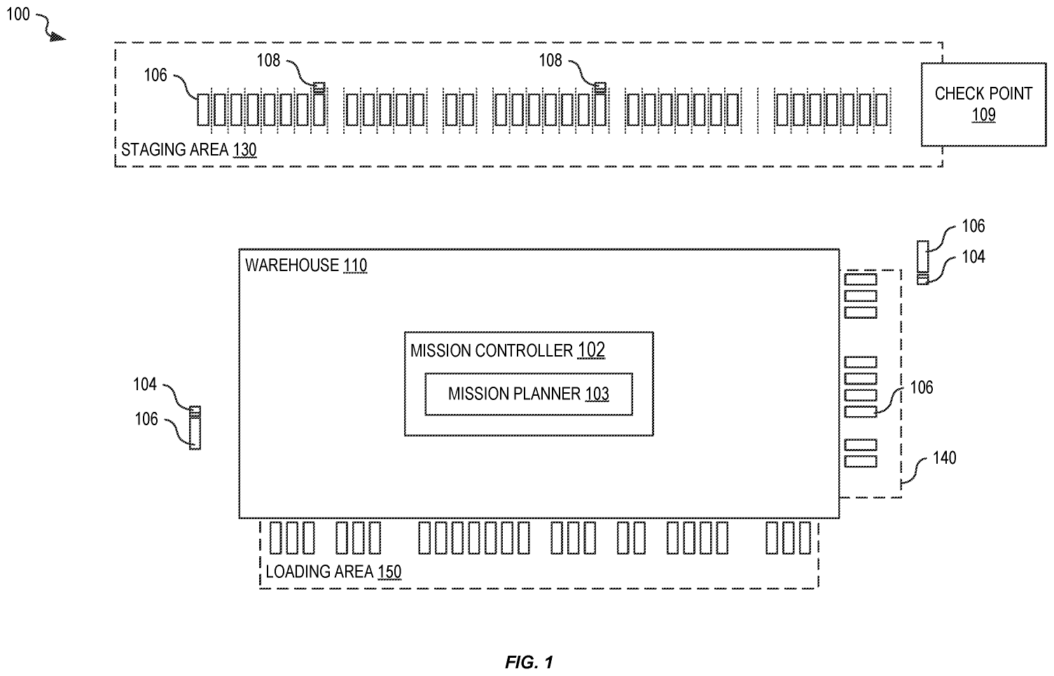

FIG. 1 is an aerial view showing one example autonomous yard 100 (e.g., a goods handling facility, shipping facility, etc.) that uses an autonomous tractor 104 to move trailers 106 between a staging area 130 and loading docks of a warehouse 110. The autonomous tractor 104 may be an electric vehicle, or may use a combustion-based engine such as a diesel tractor. For example, an over-the-road (OTR) tractors 108 deliver goods-laden trailers 106 from remote locations and retrieve trailers 106 for return to such locations (or elsewhere-such as a storage depot). In a standard operational procedure, OTR tractor 108 arrives with trailer 106 and checks-in at a facility entrance checkpoint 109. A guard/attendant enters information (e.g., trailer number or QR (ID) code scan-embedded information already in the system, which would typically include: trailer make/model/year/service connection location, etc.) into a mission controller 102 (e.g., a computer software server that may be located offsite, in the cloud, fully onsite, or partially located within a facility building complex, shown as a warehouse 110). Warehouse 110 includes perimeter loading docks (located on one or more sides of the building), associated (typically elevated) cargo portals and doors, and floor storage, all arranged in a manner familiar to those of skill in shipping, logistics, and the like.

By way of a simplified operational example, after arrival of OTR tractor 108 and trailer 106, the guard/attendant at checkpoint 109 directs the driver to deliver trailer 106 to a specific numbered parking space in a designated staging area 130, which may include a large array of side-by-side trailer parking locations, arranged as appropriate for the facility's overall layout.

Once the driver has parked the trailer in the designated parking space of the staging area 130, he/she disconnects the service lines and ensures that connectors are in an accessible position (i.e. if adjustable/sealable), and decouples OTR tractor 108 from trailer 106. If trailer 106 is equipped with swing doors, this can also provide an opportunity for the driver to unlatch and clip trailer doors in the open position, if directed by yard personnel to do so.

At some later time, (e.g., when warehouse is ready to process the loaded trailer) mission controller 102 directs (e.g., commands or otherwise controls) tractor 104 to automatically couple (e.g., hitch) with trailer 106 at a pick-up spot in staging area 130 and move trailer 106 to a drop-off spot at an assigned unloading dock in unloading area 140 for example. Accordingly, tractor 104 couples with trailer 106 at the pick-up spot, moves trailer 106 to unloading area 140, and then backs trailer 106 into the assigned loading dock at the drop-off spot such that the rear of trailer 106 is positioned in close proximity with the portal and cargo doors of warehouse 110. The pick-up spot and drop-off spot may be any designated trailer parking location in staging area 130, any loading dock in unloading area 140, and any loading dock within loading area 150.

Manual and/or automated techniques are used to offload the cargo from trailer 106 and into warehouse 110. During unloading, tractor 104 may remain hitched to trailer 106 or may decouple (e.g., unhitch) to perform other tasks. After unloading, mission controller 102 directs tractor 104 to move trailer 106 from a pick-up spot in unloading area 140 and to a drop-off spot, either returning trailer 106 to staging area 130 or delivering trailer 106 to an assigned loading dock in a loading area 150 of warehouse 110, where trailer 106 is then loaded. Once loaded, mission controller 102 directs tractor 104 to move trailer 106 from a pick-up spot in loading area 150 to a drop-off spot in staging area 130 where it may await collection by another (or the same) OTR tractor 108. Given the pick-up spot and the drop-off spot, tractor 104 may autonomously move trailer 106.

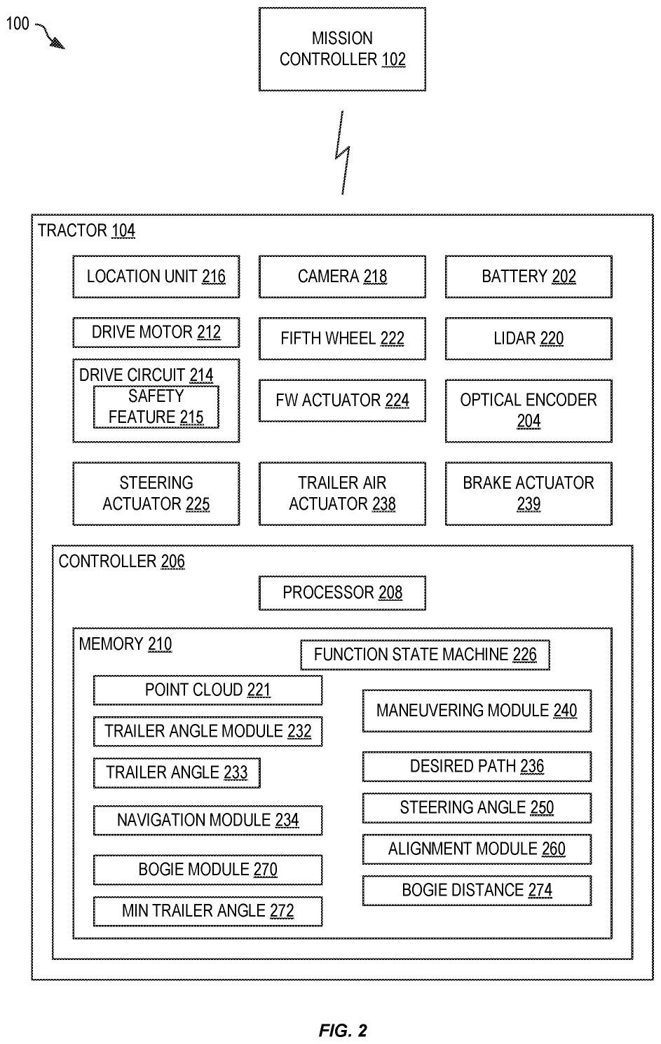

FIG. 2 is a block diagram illustrating key functional components of tractor 104. Tractor 104 includes a battery 202 for powering components of tractor 104 and a controller 206 with at least one digital processor 208 communicatively coupled with memory 210 that may include one or both of volatile memory (e.g., RAM, SRAM, etc.) and non-volatile memory (e.g., PROM, FLASH, Magnetic, Optical, etc.). Memory 210 stores a plurality of software modules including machine-readable instructions that, when executed by the at least one processor 208, cause the at least one processor 208 to implement functionality of tractor 104 as described herein to operate autonomously within autonomous yard 100 under direction from mission controller 102.

Tractor 104 also includes at least one drive motor 212 controlled by a drive circuit 214 to mechanically drive a plurality of wheels (not shown) to maneuver tractor 104. Drive circuit 214 includes a safety feature 215 that deactivates motion of tractor 104 when it detects that rotation of drive motor 212 is impeded (e.g., stalled) and that drive motor 212 is drawing a current at or greater than a stalled threshold (e.g., above one of 400A, 500A, 600A, 700A, etc. depending on the configuration of the drive motor 212), for a predetermined period (e.g., five seconds). Safety feature 215 may thereby prevent damage to tractor 104 and/or other objects around tractor 104 when tractor 104 is impeded by an object. Safety feature 215 is described above with respect to an electric tractor. It should be appreciated that a similar safety feature could be included for diesel-based tractors, such as reducing engine power when an RPM threshold goes above a pre-set threshold. When safety feature 215 is tripped, tractor 104 requires manual reactivation before being able to resume movement. Accordingly, tripping safety feature 215 is undesirable.

Tractor 104 also includes a location unit 216 (e.g., a GPS receiver) that determines an absolute location and orientation of tractor 104, a plurality of cameras 218 for capturing images of objects around tractor 104, and at least one Light Detection and Ranging (LIDAR) device 220 (hereinafter LIDAR 220) for determining a point cloud about tractor 104. Location unit 216, the plurality of cameras 218, and the at least one LIDAR 220 cooperate with controller 206 to enable autonomous maneuverability and safety of tractor 104. Tractor 104 includes a fifth wheel (FW) 222 for coupling with trailer 106 and a FW actuator 224 controlled by controller 206 to position FW 222 at a desired height. In certain embodiments, FW actuator 224 includes an electric motor coupled with a hydraulic pump that drives a hydraulic piston that moves FW 222. However, FW actuator 224 may include other devices for positioning FW 222 without departing from the scope hereof. Tractor 104 may also include an air actuator 238 that controls air supplied to trailer 106 and a brake actuator 239 that controls brakes of tractor 104 and trailer 106 when connected thereto via air actuator 238.

Controller 206 also includes a trailer angle module 232 that determines a trailer angle 233 between tractor 104 and trailer 106 based on one or both of a trailer angle measured by an optical encoder 204 positioned near FW 222 and mechanically coupled with trailer 106 and a point cloud 221 captured by the at least one LIDAR 220.

Tractor 104 also includes an alignment module 260 that provides improved localized alignment of tractor 104 such as when at a loading/unloading dock in unloading area 140 and loading area 150.

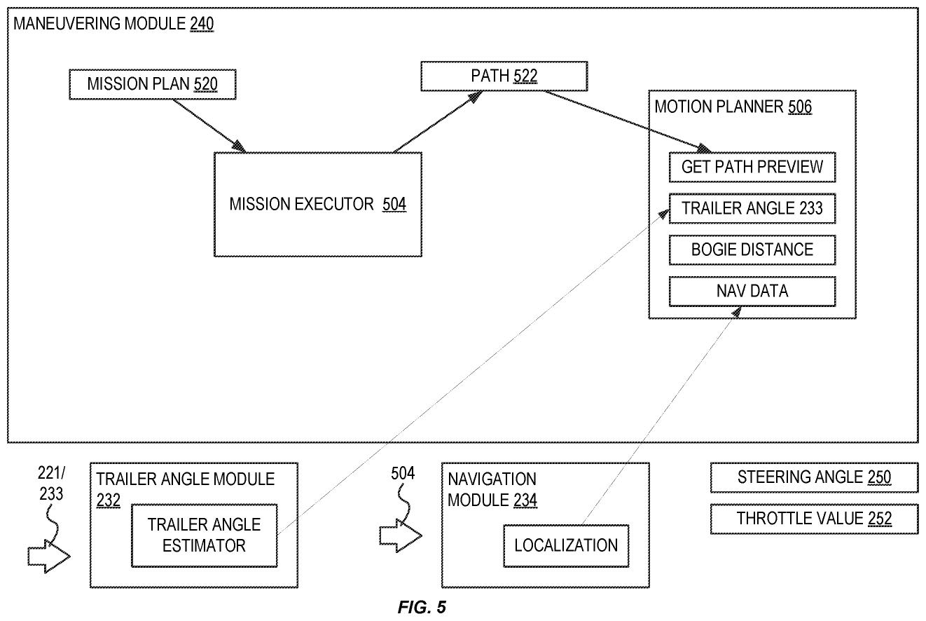

Controller 206 may implement a function state machine 226 that controls operation of tractor 104 based upon commands (requests) received from mission controller 102. For example, mission controller 102 may receive a request (e.g., via an API, and/or via a GUI used by a dispatch operator) to move trailer 106 from a first location (e.g., slot X in staging area 130) to a second location (e.g., loading dock Y in unloading area 140). Once this request is validated, mission controller 102 invokes a mission planner 103 (e.g., a software package) that computes a ‘mission plan’ (e.g., see mission plan 520, FIG. 5) for each tractor 104. For example, the mission plan is an ordered sequence of high level primitives to be followed by tractor 104, in order to move trailer 106 from location X to location Y. The mission plan may include primitives such as drive along a first route, couple with trailer 106 in parking location X, drive along a second route, back trailer 106 into a loading dock, and decouple from trailer 106.

Function state machine 226 includes a plurality of states, each associated with at least one software routine (e.g., machine-readable instructions) that is executed by processor 208 to implements a particular function of tractor 104. Function state machine 226 may transitions through one or more states when following the primitives from mission controller 102 to complete the mission plan.

Controller 206 may also include an articulated maneuvering module 240, implemented as machine-readable instructions that, when executed by processor 208, cause processor 208 to controls drive circuit 214 and steering actuator 225 to maneuver tractor 104 based on directives from mission controller 102.

Controller 206 may also include a navigation module 234 that uses location unit 216 to determine a current location and orientation of tractor 104. Navigation module 234 may also use other sensors (e.g., camera 218 and/or LIDAR 220) to determine the current location and orientation of tractor 104 using dead-reckoning techniques.

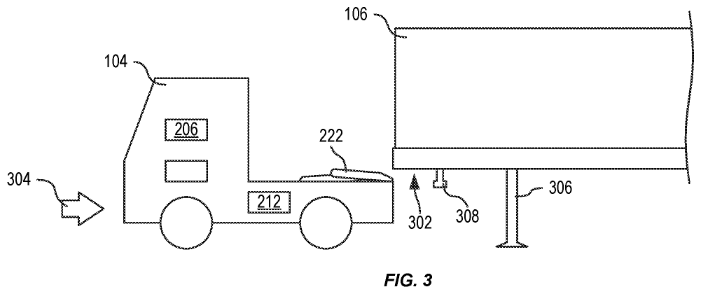

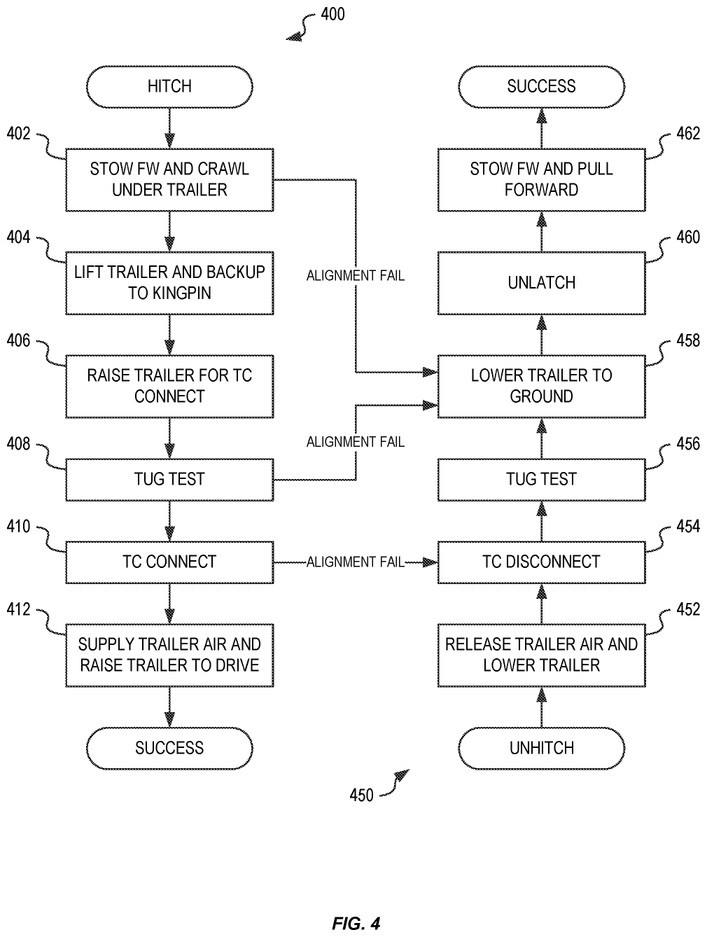

FIG. 3 is a side elevation showing tractor 104 of FIG. 1 reversing under a lower surface 302 of trailer 106. FIG. 4 shows one example hitch sequence 400 of states implemented by function state machine 226 of tractor 104, FIGS. 1-3, for coupling tractor 104 with trailer 106, and one example unhitch sequence 450 of states implemented by function state machine 226 for decoupling tractor 104 from trailer 106. FIG. 4 also shows example transitions between sequences when alignment fail is detected (e.g., when an activity of the current state fails for some reason), which allows function state machine 226 to recover from the failure (e.g., undo certain actions) and to reattempt the command. FIGS. 3 and 4 are best viewed together with the following description.

As shown in FIG. 3, landing gear 306 of trailer 106 is sufficiently extended such that a lower surface 302 (e.g., a FW plate) of a front end of trailer 106 is high enough above ground level to allow FW 222, when fully retracted, to be pushed thereunder without stalling drive motor 212 of tractor 104. That is, drive motor 212 provides sufficient force to push FW 222 under lower surface 302. However, landing gear 306 is extended by a driver of OTR tractor 108 when leaving trailer 106 in staging area 130 of autonomous yard 100, and therefore the height of lower surface 302 is at the discretion of the driver and may not be consistent between trailers 106. Further, the force required to move FW 222 under lower surface 302 is also dependent upon a weight (e.g., of goods) at the front end of trailer 106. When drive motor 212 is unable to provide sufficient force to push FW 222 beneath lower surface 302, such as when landing gear 306 is not sufficiently extended, drive motor 212 stalls.

In response to receiving a hitch command from mission controller 102, once tractor 104 is aligned with trailer 106, controller 206, in state 402, stows FW 222 and controls drive circuit 214 to move tractor 104 slowly backwards as indicated by arrow 304. When controller 206 detects that FW 222 is beneath lower surface 302 of trailer 106, drive motor 212 is stopped and function state machine 226 transitions to state 404. If controller 206 determines that tractor 104 is not correctly aligned with trailer 106, function state machine 226 transitions to state 458 of unhitch sequence 450 such that another attempt may be made. In state 404, controller 206 controls FW actuator 224 to lift trailer 106 and controls drive circuit 214 to back tractor 104, and thus FW 222, up to a kingpin 308 of trailer 106. In state 406, controller 206 controls FW actuator 224 to raise FW 222 and thereby lift the front end of trailer 106 for Trailer Connect (e.g., a process of connecting air lines/electrical from tractor 104 to trailer 106 using gladhand ID and orientation). In state 408, controller 206 controls drive circuit 214 to perform a tug test. If controller 206 determines that tractor 104 is not correctly coupled with trailer 106 (e.g., the kingpin did not latch), function state machine 226 transitions to state 458 of unhitch sequence 450 such that another attempt may be made. In state 410, controller 206 controls trailer air actuator 238 to perform the TC connect. If controller 206 determines that the TC did not connect successfully, function state machine 226 transitions to state 454 of unhitch sequence 450 such that another attempt may be made. In state 412, controller 206 controls trailer air actuator 238 to supply trailer air and controls FW actuator 224 to raise FW 222 higher to ensure that the trailer landing gear clears the ground in preparation to drive.

In response to receiving an unhitch command from mission controller1 102, once trailer 106 is correctly positioned, controller 206, in state 452, controls trailer air actuator 238 to release trailer air and controls FW actuator 224 to lower FW 222 and the front end of trailer 106. In state 454, controller 206 controls trailer air actuator 238 to disconnect the TC from trailer 106. In state 456, controller 206 controls drive circuit 214 to move tractor 104 forward to perform a tug test. In state 458, controller 206 controls FW actuator 224 to lower the front end of trailer 106 to the ground. In state 460, controller 206 controls FW actuator 224 to unlatch from the trailer kingpin. In state 462, controller 206 controls FW actuator 224 to stow FW 222 and controls drive circuit 214 to cause tractor 104 to move forward away from trailer 106.

### Articulated Backing

FIG. 5 shows maneuvering module 240 of controller 206, FIG. 2, in further example detail. Maneuvering module 240 includes a mission executor 504 and a motion planner 506. Mission executor 504 may receive, from mission planner 103 running in mission controller 102, a mission plan 520 that defines an ordered list of mission segments, where each mission segment is a high-level primitive defining at least one activity to be performed by tractor 104. Mission executor 504 executes mission plan 520 by coordinating operation of one or more components of tractor 104. For example, mission executor 504 may define at least one path 522 that motion planner 506 controls tractor 104 to follow. For example, motion planner 506 may control steering angle 250 and throttle value 252 and use one or more inputs including trailer angle 233, and navigation data (e.g., a current location and orientation) from navigation module 234, and so on, to control tractor 104 to follow path 522. Accordingly, motion planner 506 causes tractor 104 to execute maneuvers and accomplish mission goals defined by mission plan 520. Examples of mission goals include achieving a given pose (e.g., location and orientation), follow a waypoint plan, and so on. These mission goals may be defined by mission plan 520 or may be generated, based on mission plan 520, by mission executor 504.

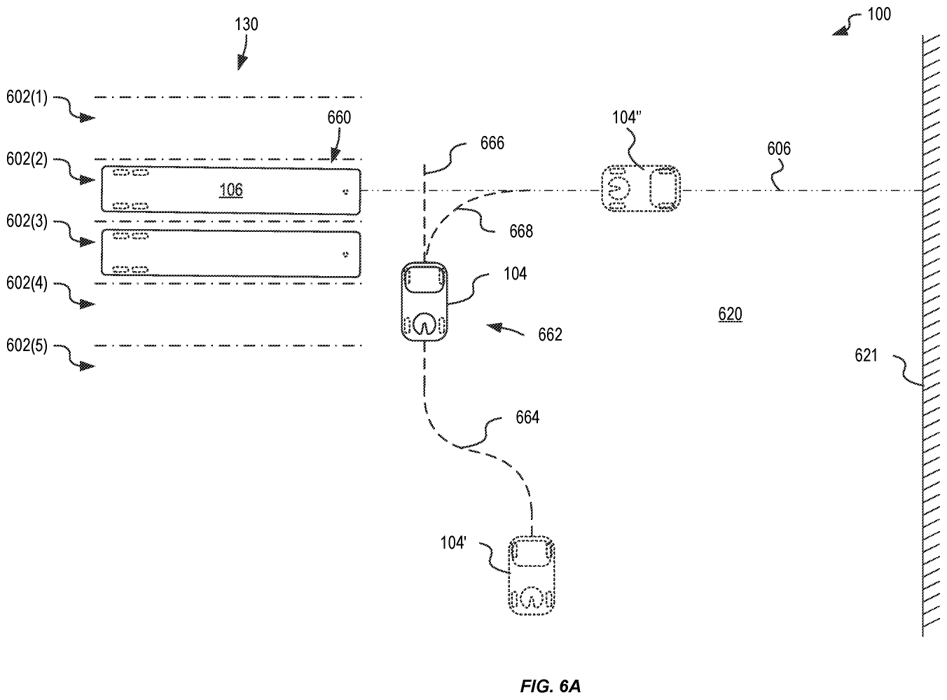

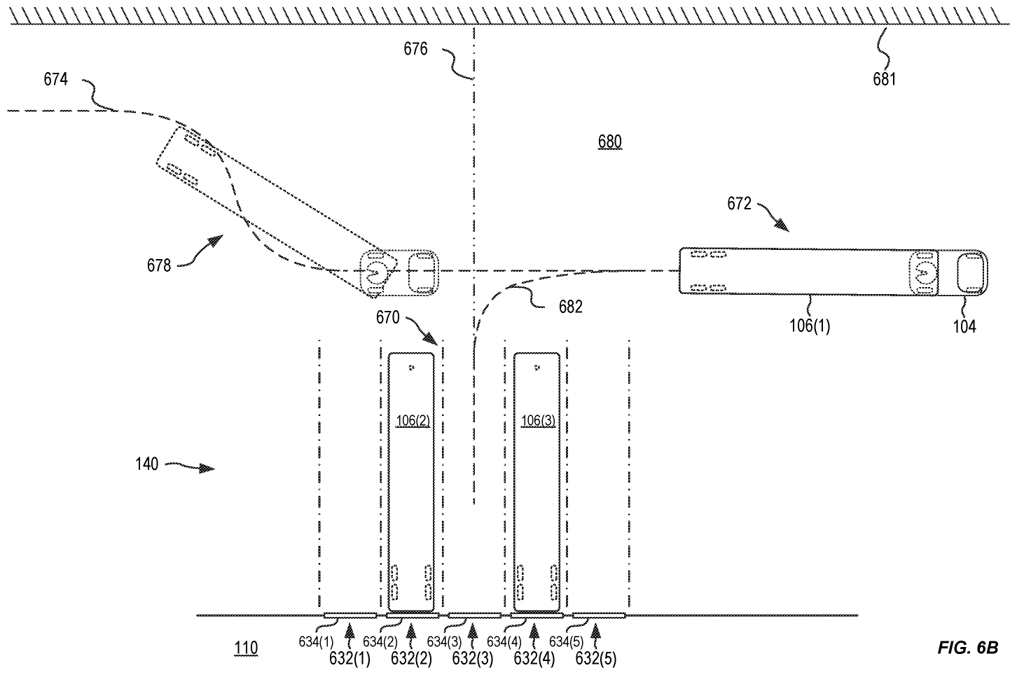

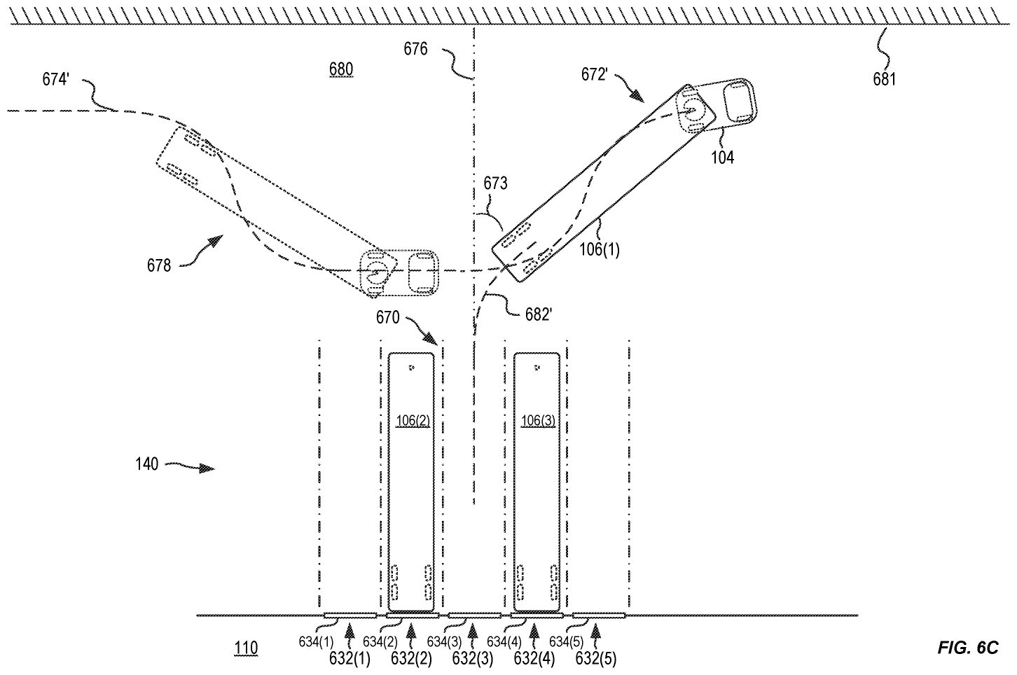

FIGS. 6A and 6B are schematic plan views illustrating one example mission for tractor 104 to collect trailer 106 from a pick-up spot 660 (e.g., a parking location 602) within staging area 130 to a deposit trailer 106 in a drop-off spot 670 (e.g., a loading dock 632) within unloading area 140 of autonomous yard 100 of FIG. 1. FIG. 6A shows tractor 104 positioned at a staging point 662 after determining and following staging path 664 to pick-up spot 660. At an initial stopping position, indicated as tractor 104′, controller 206 of tractor 104 generates staging path 664 from a current location and orientation of tractor 104 to a staging point 662, located on the apron from where tractor 104 may begin its maneuver to pick-up trailer 106 or drop-off trailer 106, and is a position prior to the pick-up spot 660 at which tractor 104 is oriented orthogonal to the orientation of pick-up spot 660 (e.g., orthogonal to a reference path 606). For trackside hitching, the staging location may be straight ahead of, and in line with, the spot.

From staging point 662, tractor 104 may perform a drive-by, indicated by path 666, of pick-up spot 660 while scanning (e.g., using one or both of LIDAR 220 and camera 218) for objects (e.g., trailer 106) within pick-up spot 660, and then returning to staging point 662. In a first example of operation, LIDAR 220 generates point cloud 221 corresponding to pick-up spot 660 as tractor 104 performs the drive-by, and controller 206 processes point cloud 221 to detect trailer 106 within pick-up spot 660. In another example of operation, camera 218 captures at least two images of pick-up spot 660 as tractor 104 performs the drive-by, and controller 206 processes the at least two images in stereo to detect trailer 106 within pick-up spot 660. When presence of trailer 106 within pick-up spot 660 is confirmed, tractor 104 performs a maneuver (such as 90-degree maneuver, or other type or angle of maneuvers), as indicated by path 668, to position it (shown as tractor 104″) on reference path 606 that is laterally aligned with a front of the pick-up spot. From this position, tractor 104 may reverse straight backwards to couple with trailer 106. Once coupled with trailer 106, tractor 104 may pull trailer 106 away from pick-up spot 660 and proceed towards a drop-off spot 670.

FIG. 6B shows tractor 104 positioning trailer 106 in preparation for backing trailer 106 into a drop-off spot 670, which in this example is one of a plurality of loading docks 632 of unloading area 140 of warehouse 110. Each loading dock 632 has a loading door 634, with which the parked trailers align. In the Example of FIG. 6B, no trailer is parked at drop-off spot 670, which corresponds to loading dock 632(3); however, loading docks 632(2) and 632(4), which are adjacent to loading dock 632(3), each have a parked trailer. Since trailer doors are at the rear of trailer 106, trailer 106 is reversed up to loading dock 632 and is correctly aligned with loading door 634 to provide full and safe access to trailer 106. A reference path 676, centered on drop-off spot 670 (e.g., loading dock 632(3)) may be determined by controller 206 to facilitate alignment of trailer 106 when backing into drop-off spot 670. Controller 206 may determine a staging path 674 for tractor 104 to follow to approach drop-off spot 670. Staging path 674 is determined based upon a starting orientation and location of tractor 104 and trailer 106 relative to drop-off spot 670 and is selected to position both tractor 104 and trailer 106 at the desired staging point 672, with the desired orientation, and with and angle of trailer 106 relative to tractor 104, substantially zero.

FIG. 6C shows alternative positioning of tractor 104 and trailer 106 in preparation for reversing trailer 106 into a drop-off spot 670. This approach makes use of space available for maneuvering to position tractor and trailer at staging point 672′ such that trailer 106 is better aligned with reference path 676 and thus requires less severe maneuvering as compared to maneuvering from staging point 672 of FIG. 6B. Accordingly, staging path 674′ forms a “U” shape for tractor 104 to follow that results in tractor 104 and trailer 106 being positioned at staging point 672′ in preparation for reversing trailer 106 into drop-off spot 670. In this embodiment, trailer angle 233 is not required to be zero at staging point 672′. The “U” shape is just one example, other “shapes” or paths may be used without departing from the scope hereof. In other words, compared to FIGS. 6A and 6B, FIG. 6C illustrates the principle that the staging point 672′ may be at a position where the trailer is not perpendicular (and in at least one embodiment forms an acute angle 673) to the final docking angle indicated by path 676.

### Pickup Trailer Method

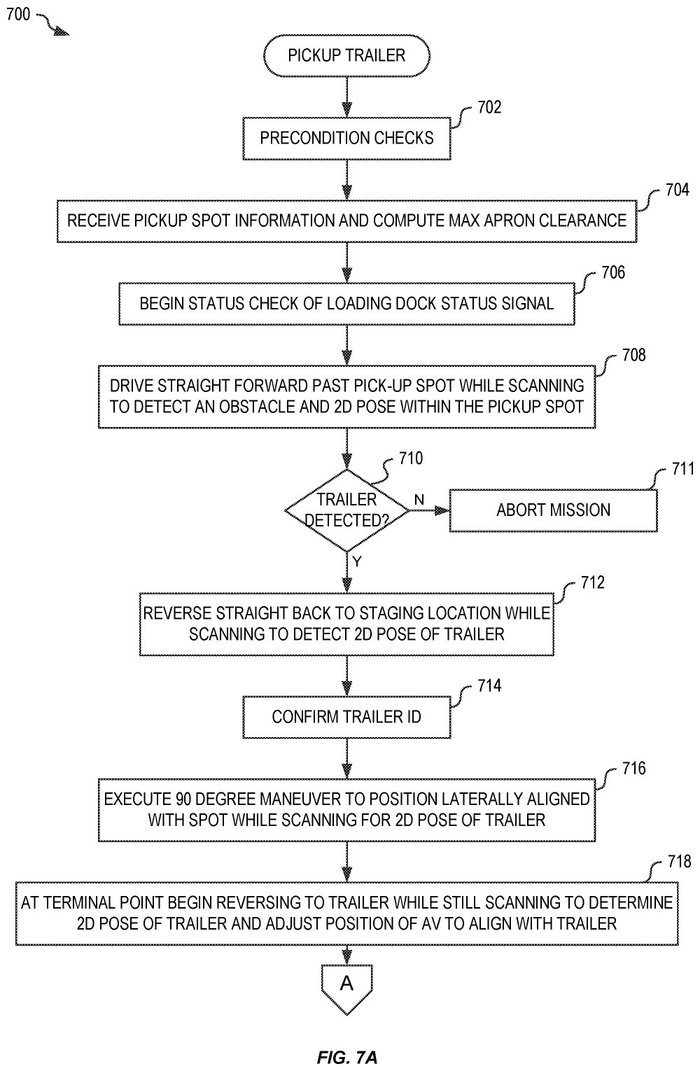

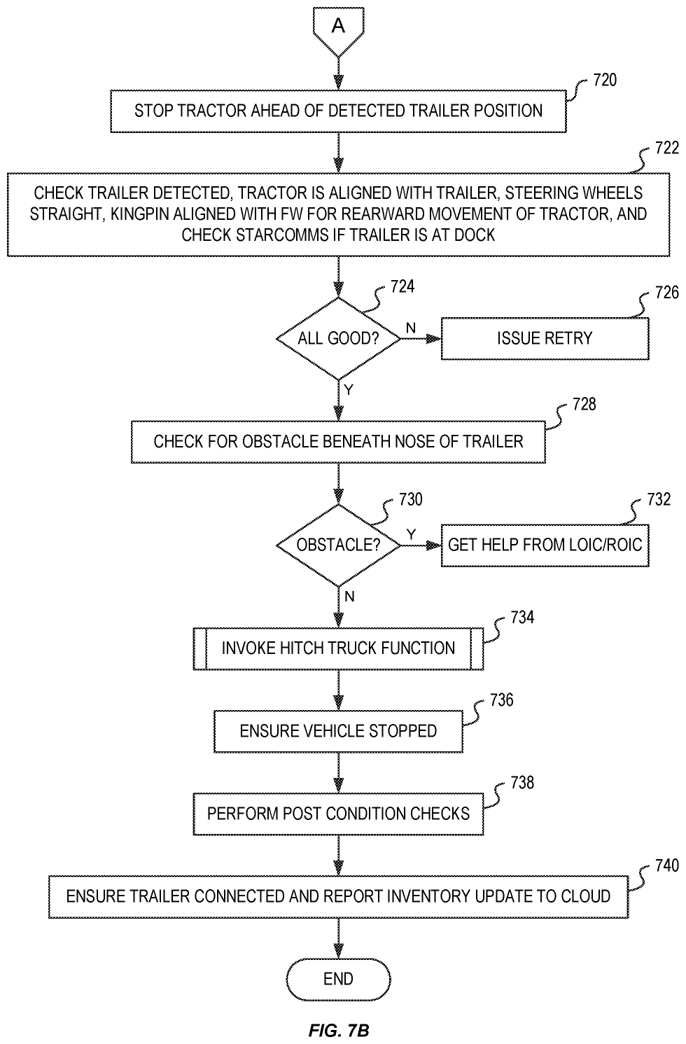

FIGS. 7A and 7B are flowcharts illustrating one example method 700 for pick-up of trailer 106 from pick-up spot 660 of FIG. 6A. Tractor 104 may receive, from mission controller 102, a mission defining a pick-up spot 660, from where tractor 104 is to collect trailer 106, and a drop-off spot 670, to where tractor 104 is to maneuver and park trailer 106. Method 700 is, for example, implemented at least in part by controller 206 of tractor 104 to cause tractor 104 to autonomously pick-up trailer 106 from pick-up spot 660.

In block 702, method 700 performs precondition checks. In one example of block 702, controller 206 ensures that tractor 104 does not have a trailer attached. In block, 704, method 700 receives at least an indication (e.g., an ID) of a pick-up spot from mission controller 102 and computes a max apron clearance for the pick-up spot. In one example of block 704, controller 206 performs, for pick-up spot 660, a freespace analysis that determines freespace 620 (e.g., maneuvering room) around pick-up spot 660 based upon known information (e.g., layout of autonomous yard 100 defining buildings, boundaries 621, and obstacles). Controller 206 may build a set of lines relative to pick-up spot 660 that increase in distance until they intersect with another polygon (e.g., another trailer parking location, another loading dock spot, a defined no-go area, etc. of autonomous yard 100) or leave the autonomous area of operation. An area within the detected intersections defines the available free space for tractor and trailer maneuvering.

Block 706 is performed when the pick-up spot is a loading dock. In block 706, method 700 begins a status check of a loading dock status signal associated with the pick-up spot. In one example of block 706, controller 206 receives (e.g., wirelessly from a module included with a loading dock signal light and/or via mission controller 102) a loading dock status signal corresponding to loading dock 632. For example, the loading dock status signal corresponds to a red light and a green light that are controlled to visually indicate a status of the loading dock, such as when workers inside the warehouse have authorized physical interaction with trailer 106 at loading dock 632 by tractor 104.

In block 708, method 700 drives straight forward past the pick-up spot while scanning the pick-up spot to detect an obstacle and a 2-dimensional pose of the obstacle. In one example of block 708, controller 206 controls tractor 104 to drive straight past pick-up spot 660 while capturing point cloud 221, using LIDAR 220, corresponding to pick-up spot 660. Point cloud 221 is then processed to detect an object (assumed to be trailer 106) within pick-up spot 660, and to determine an angle, relative to pick-up spot 660, of trailer 106 based upon a front end of trailer 106 detected within point cloud 221. In certain embodiments, controller 206 also performs object classification to automatically determine that the detected object is trailer 106 and not another vehicle parked in the pick-up spot. When controller 206 has not detected any object within the pick-up spot by the time the forward “drive-by” path execution has ended, controller 206 may request assistance from an operator remote from the tractor 104. For example, the remote operator (or a signal from a device operated thereby) may indicate that trailer 106 is present in the pick-up spot, or may confirm that there is no trailer in the pick-up spot.

Block 710 is a decision. When, in block 710, method 700 determines that the trailer is ready for pick-up, method 700 continues with block 712; otherwise, method 700 continues with block 711 and the mission is aborted. For example, when controller 206 confirms that the detected object is trailer 106 and/or when the remote operator (or a signal from a device operated thereby) indicates that trailer 106 is present in pick-up spot 660 and ready for pick-up, controller 206 proceeds with block 712 of method 700. However, when trailer 106 is not detected within the pick-up spot and the remote operator (or a signal from a device operated thereby) does not confirm the trailer is present and ready, controller 206 aborts the mission to move trailer 106 from the pick-up spot to the drop-off spot and method 700 terminates at block 711.

In block 712, method 700 reverses straight back to the original staging location for the pick-up spot, while continuing to determine pose of trailer 106. In one example of block 712, controller 206 maneuvers tractor 104 backwards to position tractor 104 back at staging point 662. In block 714, method 700 confirms the trailer ID. In one example of block 714, controller 206 may confirm an identity of trailer 106, by capturing a trailer identifier from the trailer using a trailer Id capture device (e.g., an RFID reader, a camera, or other identification system) and determine that the trailer identifier indicates the trailer is an expected trailer, thereby confirming that the correct trailer is in the pick-up spot 660.

In block 716, method 700 executes a maneuver (such as 90-degree maneuver, or other type or angle of maneuvers) to position the tractor in lateral alignment with the front of the pick-up spot while scanning to determine a 2-dimensional pose of the trailer. In one example of block 716, controller 206 causes tractor 104 to follow path 668 to position tractor 104 at a fixed offset from pick-up spot 660 on reference path 606 and in-line with pick-up spot 660 while continually capturing point cloud 221 using LIDAR 220. The fixed offset may be a set distance from a front of pick-up spot 660 but may be reduced based on available freespace 620 and any boundaries 621.

In block 718, method 700 begins reversing to the trailer from the terminal point of the maneuver while still scanning to determine the 2-dimensional pose of the trailer and adjusts the position of the AV to align with the trailer. In one example of block 718, controller 206 reverses tractor 104 towards pick-up spot 660 while continuing to capture point cloud 221 using LIDAR 220, and processing point cloud 221 to determine the pose of trailer 106. While reversing tractor 104, controller 206 may maneuver tractor 104 to better align with the front end of trailer 106.

In block 720, method 700 stops the tractor just ahead of the expected trailer position. In one example of block 720, controller 206 stops tractor 104 a preset distance in front of pick-up spot 660 and aligned with trailer 106. In certain embodiments, if the ID of trailer 106 was not previously confirmed, controller 206 may confirm the ID of trailer 106 with a remote operator. In block 722, method 700 checks that the trailer is detected, that the tractor is aligned with the trailer, that the steering wheels are straight, that the kingpin is aligned to be captured by the FW when the tractor moves backwards, and, if the trailer is at a loading dock, checks to ensure that the tractor is permitted to couple with the trailer. In one example of block 722, controller 206 confirms that trailer 106 is detected in point cloud 221, determines that tractor 104 is aligned with the front of trailer 106, determines that steering actuator 225 is set to straight, and that, based on the perceived location and orientation of trailer 106 determined from at least point cloud 221, FW 222 will engage kingpin 308 of trailer 106 when tractor 104 is driven backwards. When pick-up spot 660 is a loading dock, controller 206 also communicated via a dock and tractor communication apparatus to ensure that tractor 104 is authorized and permitted to couple with trailer 106. These checks prevent perception error and alignment error from causing an incorrect coupling attempt.

Block 724 is a decision. If, in block 724, method 700 determines that all checks have passed, method 700 continues with block 728; otherwise, method 700 continues with block 726. In block 726, method 700 issues a retry. In one example of block 726, controller 206 causes tractor 104 to move away from pick-up spot 660 and towards a far side of the apron (e.g., along reference path 606) and repeats backing of tractor 104 towards trailer 106. Method 700 may then continue with block 712 for example.

In block 728, method 700 checks for obstacles beneath the nose of the trailer. In one example of block 728, controller 206 controls one or more camera 218 and/or LIDAR 220 that face trailer 106 to capture data corresponding to a volume beneath the front end of trailer 106 that the tractor needs to use to couple with trailer 106. This volume does not continue as far back as landing gear 306, for example. Controller 206 then processes the captured data to detect obstacles that may prevent tractor 104 from coupling with trailer 106. Block 730 is a decision. If, in block 730, method 700 determines that an obstacle is detected beneath the front end of the trailer, method 700 continues with block 732; otherwise, method 700 continues with block 734. In block 732, method 700 requests help from a remote operator or remote device to evaluate the object. In one example of block 734, controller 206 sends a message, including the captured data (e.g., one or more of images and/or point cloud 221) defining the detected obstacle, to the remote operator or remote device and requesting clarification of the detected object. Where the remote operator or remote device responds to indicate that tractor 104 may proceed with the coupling, method 700 continues with block 734; otherwise, method 700 may cause tractor 104 to await manual assistance to remove the object and/or aborts the mission.

In block 734, method 700 invokes a hitch tractor function. In one example of block 734, controller 206 invokes hitch sequence 400 of FIG. 4 to cause tractor 104 to couple with trailer 106. For example, hitch sequence 400 causes tractor 104 to push beneath trailer 106, retrying if needed, raise FW 222 and back tractor 104 to engage kingpin 308 of trailer 106 (e.g., using a FW latch sensor and kingpin presence sensor), perform a tug test, perform the TC connect, supply trailer 106 with air, and raise FW 222 to lift landing gear 306 off the ground in preparation for moving trailer 106.

In block 736, method 700 ensures tractor 104 is stopped (e.g., tractor and trailer are stationary). In one example of block 736, as a safety check, controller 206 ensures hitch sequence 400 has completed and is no longer commanding movement of tractor 104. In block 738, method 700 performs post condition checks. In one example of block 738, controller 206 reads one or more sensors of tractor 104 to verify that FW 222 is locked and kingpin 308 is captured by FW 222. In block 740, method 700 ensures the trailer is connected and reports the inventory update to the cloud. In one example of block 740, controller 206 verifies that trailer 106 is correctly coupled with tractor 104 and reports the inventory update (e.g., based in an ID of trailer 106) to mission controller 102. Method 700 then terminates.

### Trailer Backing Method

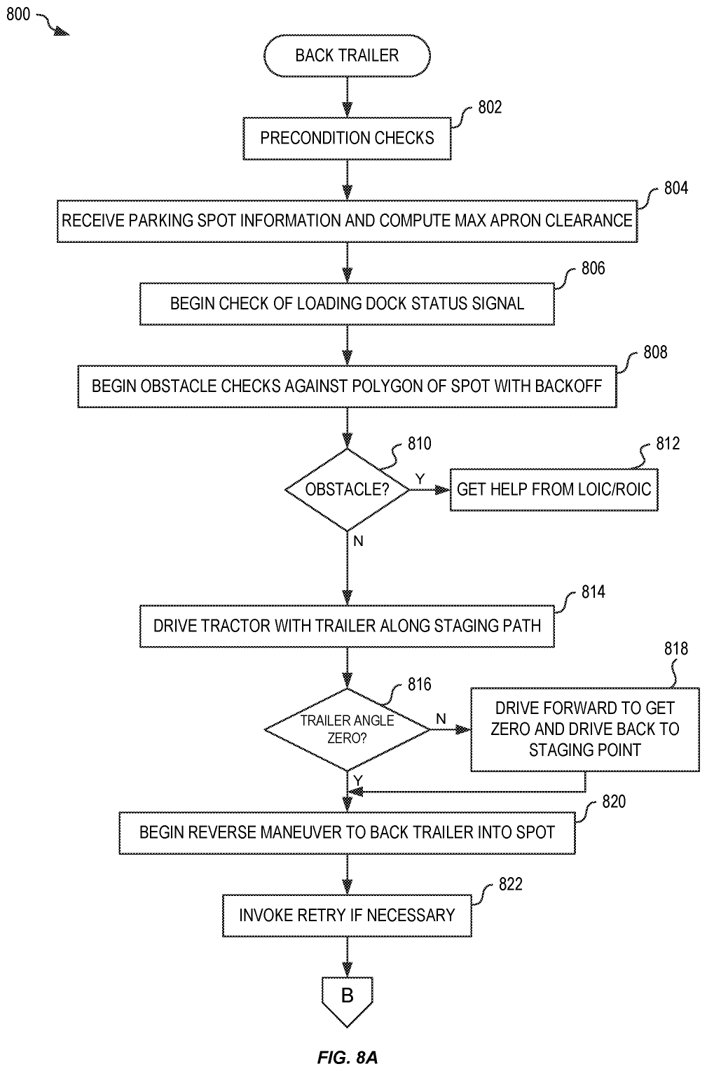

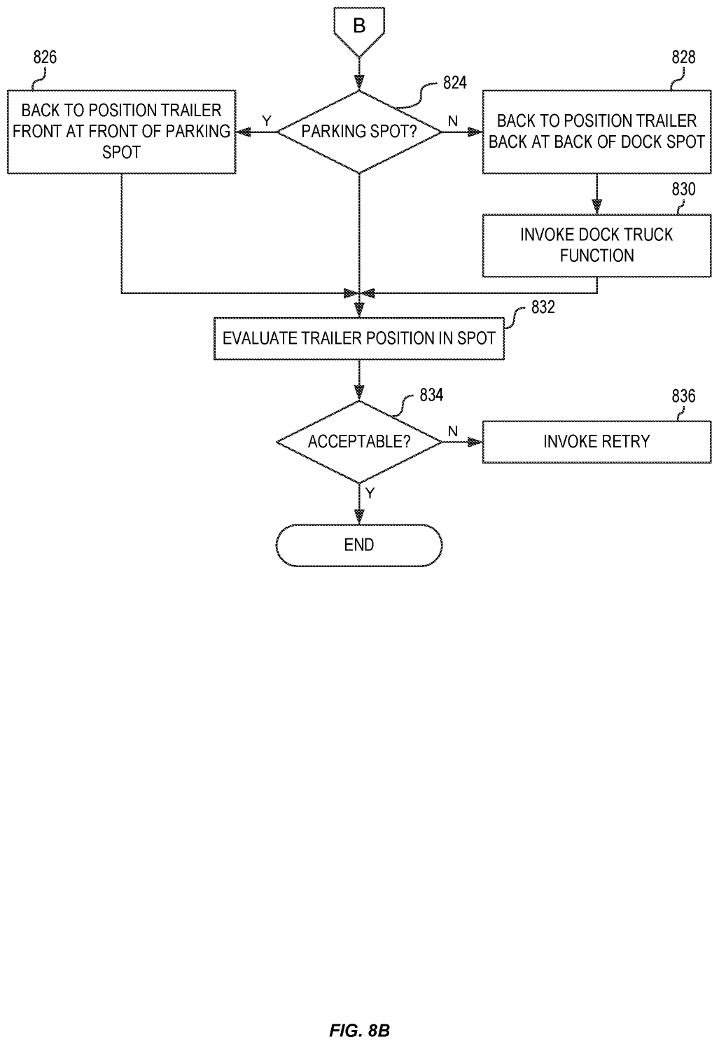

FIGS. 8A and 8B are flowcharts illustrating one example method 800 for backing trailer 106 into drop-off spot 670 of FIG. 6B. The following example continues the mission, received from mission controller 102, to move trailer 106 from pick-up spot 660 to drop-off spot 670. Method 800 is, for example, implemented at least in part by controller 206 of tractor 104 to cause tractor 104 to autonomously back trailer 106 into drop-off spot 670. In block 802, method 800 performs precondition checks. In one example of block 802, controller 206 checks that trailer 106 is attached to tractor 104 by verifying that FW222 is locked and kingpin 308 is sensed within FW 222. In block 804, method 800 received drop-off spot information and computes maximum apron clearance. In one example of block 804, controller 206 uses location information of drop-off spot 670, received from mission controller 102, to compute freespace 680 near drop-off spot 670 by projecting lines radially from a front location of drop-off spot 670 to intersect with a line of any polygon defining structure (e.g., another trailer parking spot, a no-go area, an area boundary 681, a building, a wall, etc.) of autonomous yard 100.

Block 806 is only executed when drop-off spot 670 is a loading dock. In block 806, method 800 begins checking the loading dock status signal. In one example of block 806, controller 206 receives the loading dock status signal indicative of loading dock 632(3) at drop-off spot 670 being ready to receive trailer 106.

In block 808, method 800 begins obstacle checks against a polygon of drop-off spot with backoff. Any object detected within drop-off spot 670 may prevent trailer 106 from entering or being parked at drop-off spot 670. In one example of block 808, controller 206 uses LIDAR 220 to capture point cloud 221 of drop-off spot 670 and processes point cloud 221 to detect objects within drop-off spot 670, allowing for backoff of a small distance that ensures that trailer bumpers at a loading dock and a parking curb within staging area 130 are not detected as objects preventing parking of trailer 106. In certain embodiments, controller 206 may also use other sensors (e.g., cameras and RADAR) to capture data of drop-off spot 670 that may also, or alternatively, be used to detect objects within drop-off spot 670 that may prevent parking of trailer 106 therein.

Block 810 is a decision. If, in block 810, method 800 determines that an obstacle is present, method continues with clock 812; otherwise, method 800 continues with block 814. In block 812, method 800 gets help from a remote operator or remote device.

In block 814, method 800 drives the tractor and the trailer forwards along a staging path. In one example of block 814, controller 206 controls tractor 104 to pull trailer 106 along staging path 674 that positions tractor 104 and trailer 106 for reversing into drop-off spot 670. In another example of block 814, tractor 104 follows staging path 672′ of FIG. 6C to position tactor 104 and trailer 106 at staging point 672′. Blocks 816 and 818 are omitted when using staging path 672′ since it is not required that trailer angle 233 is zero prior to reversing.

Block 816 is a decision. If, in block 816, method 800 determines that the trailer angle is not within a predefines tolerance of zero, method 800 continues with block 818; otherwise, method 800 continues with block 820. In one example of block 816, while tractor 104 is stopped at staging point 672, controller 206 determines, based on trailer angle 233 being approximately zero, whether trailer 106 is aligned with tractor 104. In block 818, when the trailer angle is not close enough to zero and to correct the trailer angle, method 700 moves (e.g., called a “push-out” maneuver) tractor 104 forward in a straight line for a predefined distance, and then reverses tractor 104 and trailer 106 straight backwards to staging point 672. Staging path 674 is designed with a built-in push-out, but in certain circumstances, the built-in push-out is insufficient to straighten trailer 106. When backing trailer 106, it is advantageous to start the backing with a substantially zero trailer angle.

In block 820, method 800 begins the reversing maneuver to back the trailer into the drop-off spot. In one example of block 820, controller 206 controls tractor 104 to back trailer 106 along backing path 682 of FIG. 6B into drop-off spot 670. For example, controller 206 may control steering actuator 225 of tractor 104 to maneuver tractor 104 into freespace 680 as needed to reverse the back end of trailer 106 along backing path 682 and into drop-off spot 670 without trailer 106 or tractor 104 encroaching on other parking spaces or structures of autonomous yard 100. In another example of block 820, controller 206 controls tractor 104 to back trailer 106 along backing path 682′ of FIG. 6C into drop-off spot 670. In block 822, method 800 invokes a retry if necessary. In one example of block 822, controller 206 detects that the current location of trailer 106 relative to backing path 682 exceeds a predefined tolerance and invokes a retry of the backing maneuver, whereby controller 206 controls tractor 104 to pull forward, along reference path 676 for example, to align with drop-off spot 670, and then reverses trailer 106 into drop-off spot 670, along reference path 676 for example.

Block 824 is a decision. If, in block 824 method 800 determines that the drop-off spot is a parking spot, method 700 continues with block 826; otherwise, method 800 continues with block 828. In block 826, method 800 backs to position the trailer front end at a front of the parking spot. In one example of block 826, controller 206 positions a front end of trailer 106 at a front of drop-off spot 670. For example, this positions the front of each trailer at the front of the parking spot irrespective of trailer length. Geometry of each parking spot is defined when autonomous yard 100 is commissioned, whereby each parking spot may be sized to accommodate all trailer lengths used within autonomous yard 100. Method 800 continues with block 832.

In block 828, method 800 backs to position the trailer back at the back of the drop-off spot. In one example of block 828, controller 206 backs trailer 106 into drop-off spot 670 such that the back end of trailer 106 is at the back end of drop-off spot 670. Since drop-off spot 670 is a loading dock (e.g., loading dock 632(3)), it is important that the back end of trailer 106 be immediately in front of loading dock door 634(3). In block 830, method 800 invokes a dock tractor function. In one example of block 830, controller 206 invokes a dock function that uses drive circuit 214 to applies throttle to push trailer 106 against bumpers of loading dock 632(3) to minimize rebound, and brakes of trailer are applied such that trailer 106 remains positioned directly in front of loading dock 632(3).

In block 832, method 800 evaluates whether the trailer is positioned within the drop-off spot acceptably. In one example of block 832, controller 206 uses one or more of location unit 216, trailer angle 233, known dimensions of trailer 106, camera 218, and LIDAR 220 to evaluate the position of trailer 106 within drop-off spot 670. Where drop-off spot 670 is a parking spot, controller 206 determines that trailer 106 is contained within the polygon defined for the parking spot. Where drop-off spot 670 is a loading dock, controller 206 evaluates whether an estimated position of the back end of trailer 106 is within a desired lateral accuracy of a center (e.g., a reference path 676) of loading dock 632(3).

Block 834 is a decision. If, in block 834, method 800 determines that the position of trailer is acceptable, method 800 terminates; otherwise, method 800 continues with block 836. In block 836, method 800 invokes a retry. In one example of block 836, controller 206 controls tractor 104 to pull trailer 106 straight ahead (e.g., along reference path 676) for a distance determined by freespace 680 (e.g., from apron clearance). At the end of this path, controller 206 control tractor 104 to back trailer 106 along reference path 676 into drop-off spot 670, repeating blocks 820 through 834 up to a maximum number of retries.

### Trailer Drop-Off Method

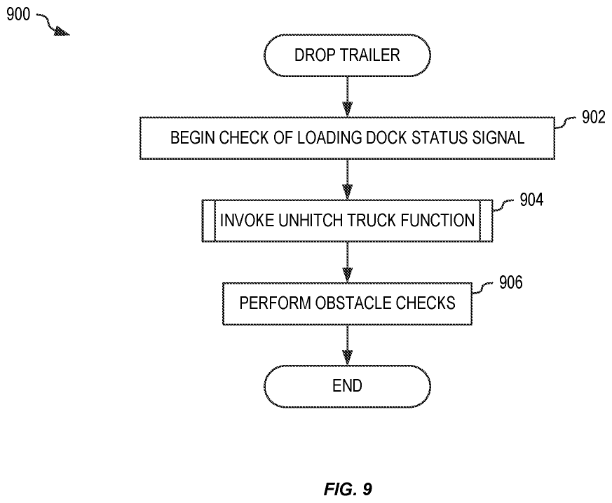

FIG. 9 is a flowchart illustrating one example method 900 for depositing trailer 106 at drop-off spot 670. Method 900 is implemented within controller 206 of tractor 104 for example and is invoked to unhitch tractor 104 from trailer 106 once trailer 106 is positioned correctly within drop-off spot 670.

Block 902 is executed when the drop-off spot is a loading dock. In block 902, method 900 begins checking a loading dock status signal. In one example of block 902, controller 206 receives the loading dock status signal of loading dock 632 to determine whether loading dock 632 is ready to receive trailer 106. In block 904, method 900 invokes an unhitch tractor function. In one example of block 904, controller 206 invokes unhitch sequence 450 of FIG. 4 to unhitch tractor 104 from trailer 106. For example, unhitch sequence 450 disconnects the emergency air line from trailer 106, opens the latch on FW 222, drives tractor 104 forwards a short, defined distance that keeps the front of trailer 106 on FW 222, lowers FW 222 and such that landing gear 306 of trailer 106 are on the ground, and then drives tractor 104 forward such that it is out from underneath trailer 106.

In block 906, method 900 performs obstacle checks. In one example of block 906, controller 206 uses one or both of cameras 218 and LIDAR 220 to check for obstacles in front of tractor 104 prior to driving tractor 104 forwards.

### Staging Path Generation

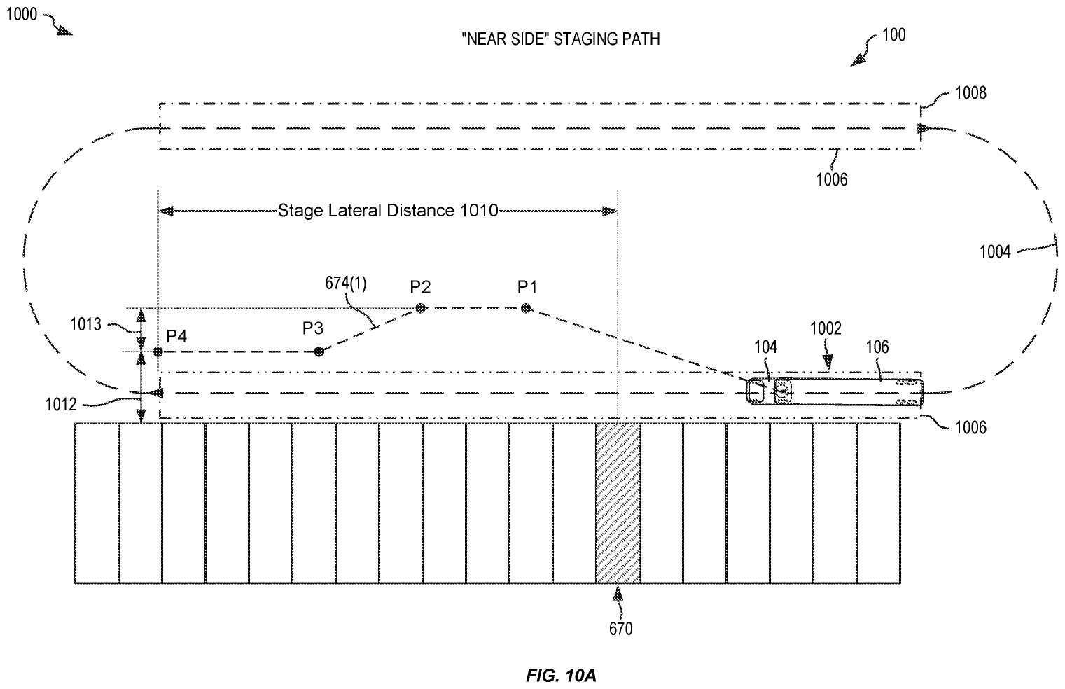

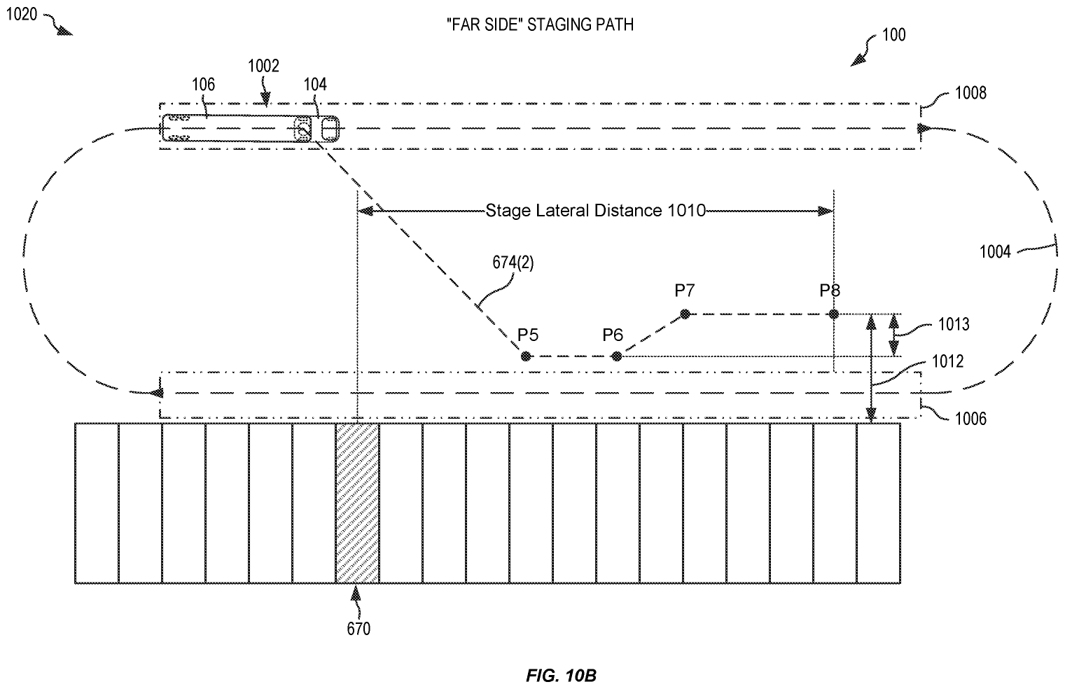

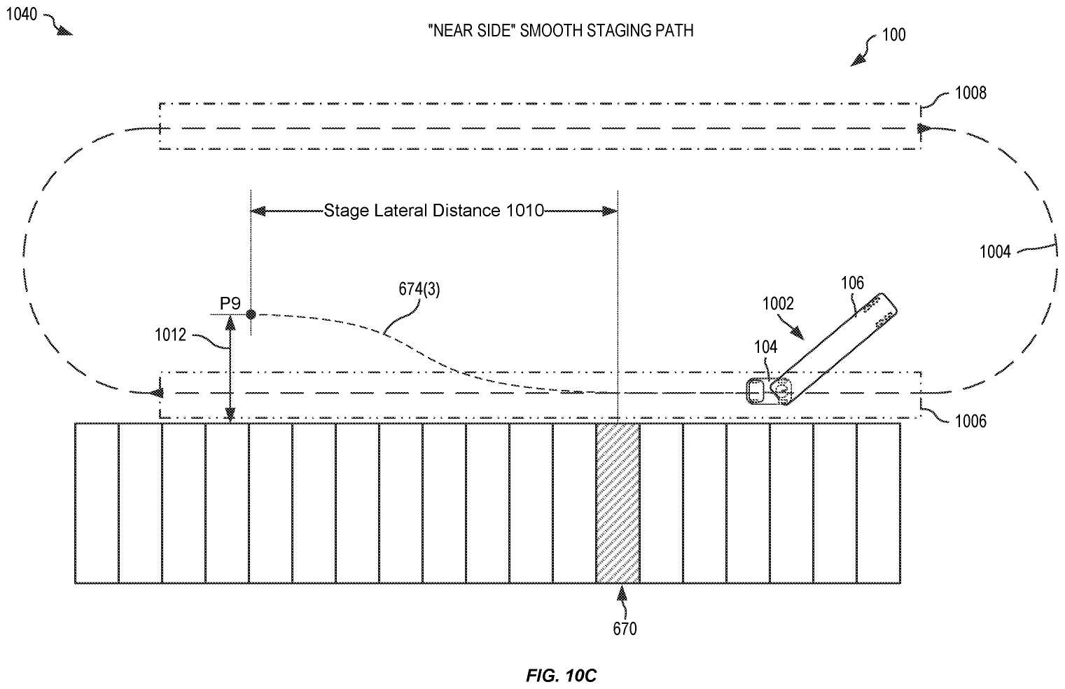

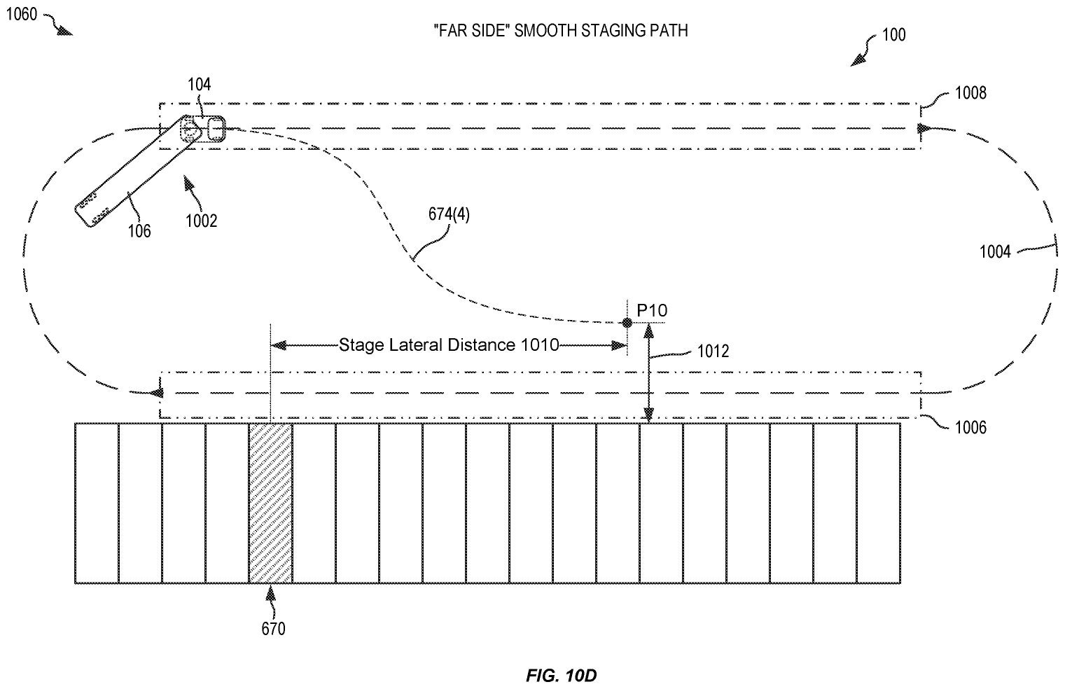

FIGS. 10A-10D are example schematic plan diagrams illustrating how staging path 674 (see FIG. 6) is determined based on a position and orientation of tractor 104 and trailer 106 (hereinafter vehicle 1002) relative to the designated drop-off spot 670. When moving trailer 106 from a pick-up spot (e.g., pick-up spot 660) to a drop-off spot (e.g., drop-off spot 670), vehicles 1002 may follow a loop 1004 that defines a common maneuvering path followed by tractor 104 through a portion of autonomous yard 100. For example, loop 1004 defines a path an apron of autonomous yard 100 that passes in front of drop-off spot 670 in a first direction and passes on an opposite side of the apron on the opposite direction, as shown in FIGS. 10A-10D. Accordingly, for the designated drop-off spot 670, loop 1004 has a near-side area 1006 and a far side area 1008, as shown. Depending on the location and orientation of vehicle 1002, four possible shapes of staging path 674 may be generated, such that when tractor 104 follows staging path 674, vehicle 1002 is positioned and aligned in preparation for tractor 104 to back trailer 106 into drop-off spot 670. For example, at the end of staging path 674, trailer 106 should have a substantially zero trailer angle 233.

FIG. 10A shows a first scenario where vehicle 1002 is positioned within near-side area 1006 and that results in a first example shape of a staging path 674(1) that is defined by four points P1, P2, P3, and P4. Points P1, P2, P3, and P4 are positioned relative to a center front point of drop-off spot 670, where point P4 is a stage lateral distance 1010 from the center front point of drop-off spot 670 and points P3 and P4 are located a stage longitudinal distance 1012 from the front of drop-off spot 670. Points P1 and P2 are located stage longitudinal distance 1012 plus a punch-out distance 1013 from the front of drop-off spot 670, and define a maneuver for tractor 104 to better align trailer 106. The orientation of vehicle 1002 defines a direction that staging path 674(1) follows, and a current position of vehicle 1002 defines a first part of staging path 674(1) from the current position of vehicle 1002 to point P1. After following staging path 674(1), vehicle 1002 is positioned at point P4 and aligned in preparation for backing trailer 104 into drop-off spot 670.

FIG. 10B shows a second scenario where vehicle 1002 is positioned within far-side area 1008 and that results in a second example shape of a staging path 674(2) that is defined by four points P5, P6, P7, and P8. Points P5, P6, P7, and P8 are positioned relative to a center front point of drop-off spot 670, where point P8 is stage lateral distance 1010 from the center front point of drop-off spot 670 and points P7 and P8 are stage longitudinal distance 1012 from the front of drop-off spot 670. Points P5 and P6 are located stage longitudinal distance 1012 minus punch-out distance 1013 from the front of drop-off spot 670, and define a maneuver for tractor 104 to better align trailer 106. The orientation of vehicle 1002 defines a direction that staging path 674(2) follows, and a current position of vehicle 1002 defines a first part of staging path 674(2) from the current position of vehicle 1002 to point P5. After following staging path 674(2), vehicle 1002 is positioned at point P8 and aligned in preparation for backing trailer 104 into drop-off spot 670.

FIG. 10C shows a third scenario where vehicle 1002 is positioned within near-side area 1006 that results in a third example shape of a staging path 674(3), which is generated by a smooth curve generator from the current position of vehicle 1002 to a staging point P9. Point P9 is positioned stage lateral distance 1010 from the center front point of drop-off spot 670 and stage longitudinal distance 1012 from the front of drop-off spot 670. The orientation of vehicle 1002 defines a direction that staging path 674(3) follows and a tangent of the starting point and a tangent of the ending point of staging path 674(3) are substantially parallel with the front of drop-off spot 670. After following staging path 674(3), vehicle 1002 is positioned at point P9 and aligned in preparation for backing trailer 104 into drop-off spot 670. Given the initial large angle between trailer 106 and tractor 104, no punch-out distance 1013 based maneuver is required to align trailer 106 with tractor 104.

FIG. 10D shows a fourth scenario where vehicle 1002 is positioned within far-side area 1008 and results in a fourth example shape of a staging path 674(4), generated by the smooth curve generator from the current position of vehicle 1002 to a staging point P10. Point P10 is positioned stage lateral distance 1010 from the center front point of drop-off spot 670 and stage longitudinal distance 1012 from the front of drop-off spot 670. The orientation of vehicle 1002 defines a direction that staging path 674(4) follows and a tangent of the starting point and a tangent of the ending point of staging path 674(4) are substantially parallel with the front of drop-off spot 670. After following staging path 674(4), vehicle 1002 is positioned at point P10 and aligned in preparation for backing trailer 104 into drop-off spot 670. Given the initial large angle between trailer 106 and tractor 104, no punch-out distance 1013 based maneuver is required to align trailer 106 with tractor 104.

In one example, stage lateral distance 1010 and stage longitudinal distance 1012 may be defined based on the length of the trailer. There may be different distance values for stage lateral distance 1010 and stage longitudinal distance 1012 different lengths of trailers. Moreover, the distance between points P1 to P2, P2 to P3, P3 to P4, P5 to P6, P6 to P7, and P7 to P8 may be pre-set percentages of the stage lateral distance 1010. P1 to P2, P2 to P3, P5 to P6, and P6 to P7 may be all be a first percentage of stage lateral distance 1010 (or different percentages), and P3 to P4 and P7 to P8 may be a second percentage of the stage lateral distance 1010 (or different percentages), where the second percentage is greater than the first percentage. Other distances and percentages of the stage lateral distance 1010 may be used without departing from the scope hereof.

### Fiducial Markers

Correct alignment of trailer 106 with loading dock 632 (see FIG. 6B) is critical to allow correct operation and movement of cargo on and off trailer 106. For example, loading dock 632 may include dock levelers, securing hooks, etc., that expect trailer to be in a certain position for coupling therewith. Thus, misalignment of trailer 106 with loading dock 632 and loading door 634 can be a safety issue. Although tractor 104 does not require a “view” to be able to maneuver trailer 106 into loading dock 632, tractor 104 may use one or more cameras 218 to improve alignment of trailer 106 with loading dock 632. Further, to facilitate recognition of loading dock 632 within images of cameras 218, one or more fiducial markers may be applied at loading dock 632.

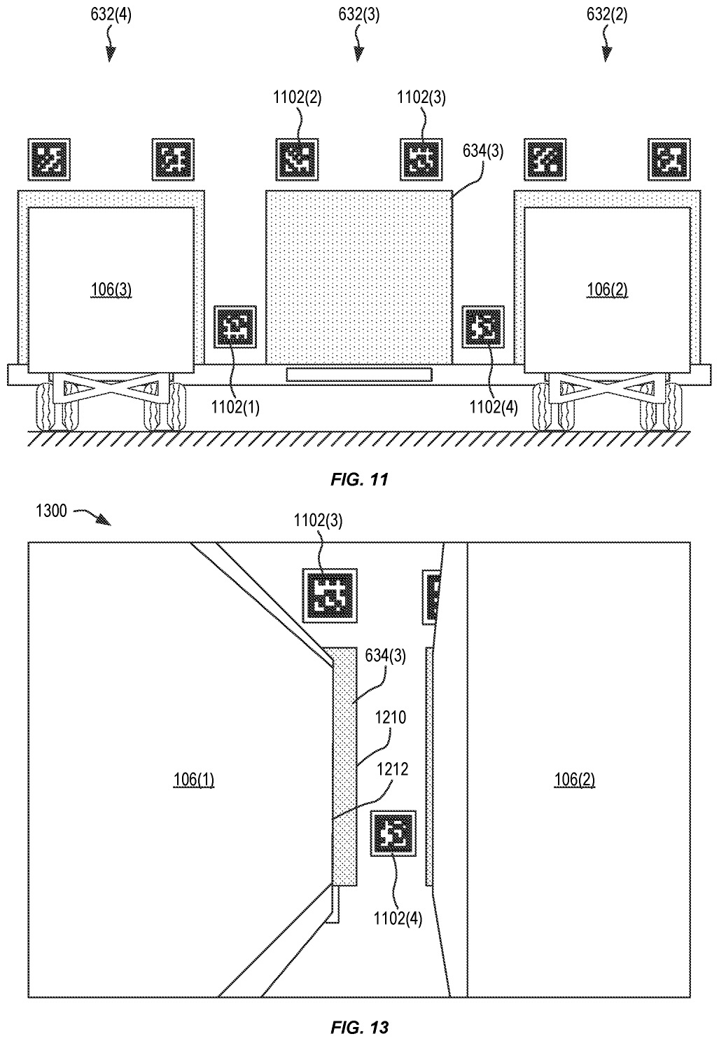

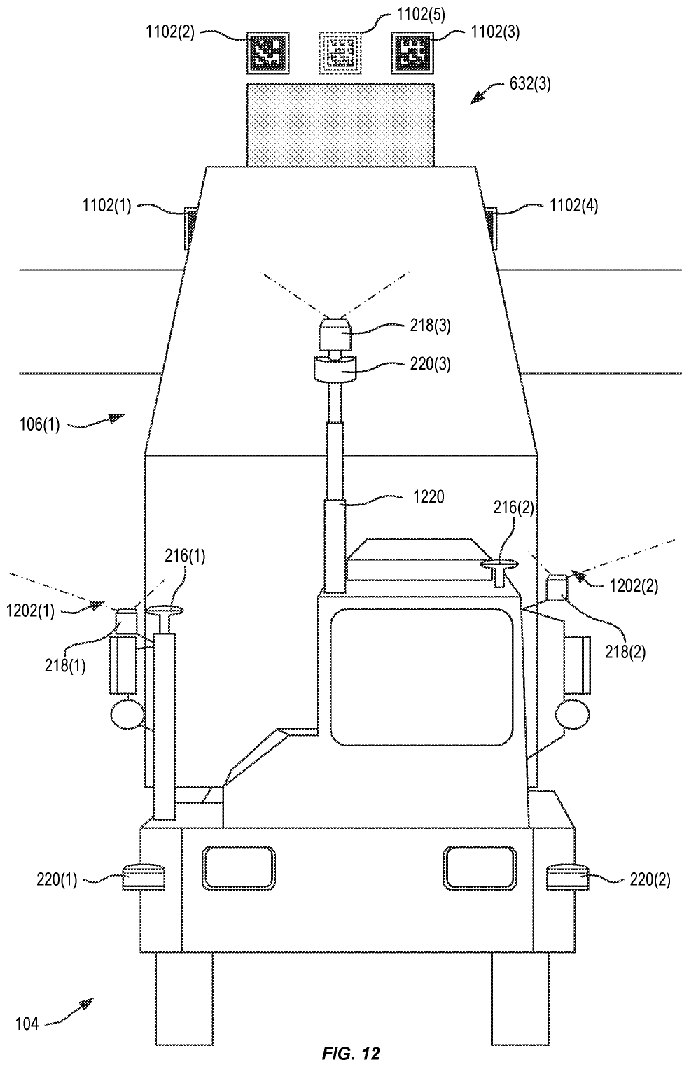

Continuing the example of FIG. 6B, FIG. 11 is a front view of loading dock 632(2), prior to arrival of trailer 106, showing two fiducial markers 1102(2) and 1102(3) positioned above loading door 634(2), one fiducial marker 1102(1) positioned between adjacent loading docks 634(3) and 634(4), and one fiducial marker 1102(4) positioned between loading doors 634(3) and 634(2). However, more or fewer fiducial marks may be used without departing from the scope hereof. FIG. 12 is a perspective view showing tractor 104 reversing trailer 106 into loading dock 632(3) of FIG. 11. FIG. 13 shows one example image 1300 captured by camera 218(2) as trailer 106 nears loading door 634(3). FIGS. 11-13 are best viewed together with the following description.

Each fiducial marking 1102 is positioned at loading dock 632 and its position, relative to at least the corresponding loading dock 632 (e.g., relative to a center line of a preferred alignment for the loading dock), is accurately determined. In certain embodiments, fiducial markings 1102(2) and 1102(4) are positioned at a height of two meters above the ground. Once affixed to loading dock 632, each fiducial marking 1102 may be surveyed to determine its position, relative to loading dock 632 and/or its absolute position, accurately. In the example of FIGS. 11-13, fiducial markings 1102 are QR codes that may include information that uniquely identifies the fiducial marking, thereby allowing controller 206 to decode the QR code and “look-up” a corresponding position of the fiducial marking. However, fiducial markers 1102 may represent other types of fiducial marker without departing from the scope hereof. In certain embodiments, fiducial markings 1102 are retroreflectors or active lights that are easily detected by cameras 218. In certain embodiments, a frame of loading door 634 may be marked (e.g., painted) such that it is easily identified within captured images (e.g., image 1300).

As shown in FIG. 12, tractor 104 has two rear-facing cameras 218(1)-(2), one positioned at each side of tractor 104, near wing mirrors for example, such that each has a rearward field of view 1202 that includes a corresponding side of trailer 106. As tractor 104 is reversing trailer 106 into loading dock 632(3), controller 206 evaluates images (e.g., image 1300) captured by cameras 218, identifies any fiducial markings 1102 captured in the images, and computes a relative navigation solution for tractor 104 relative to the identified fiducial markings 1102 and their position within the images. In the example of FIG. 13, image 1300 includes fiducial markings 1102(3) and 1102(4). By using fiducial markings 1102, alignment module 260 may determine improved location and orientation of tractor 104 relative to loading dock 632(3), as compared to location and orientation determined by location unit 216 from an inertial navigation system and/or odometry where drift errors may occur, and from availability of GPS signals where discontinuities and canyon effect errors may occur. Advantageously, through use of fiducial markings 1102, alignment module 260 may determine position and orientation of tractor 104 relative to loading dock 632 more accurately, and thereby improve positioning of trailer 106 at loading dock 632. For example, by using fiducial markings 1102, tractor 104 may position trailer 106(1) at loading dock 632(3) to an accuracy of within three inches.

In certain embodiments, another camera 218(3) may be fitted to an extendable mast 1220 coupled with tractor 104. As trailer 106 approaches loading dock 632, mast 1220 may be extended to provide camera 218(3) with a higher vantage point that provides camera 218(3) with a view over trailer 106. For example, where building structure and/or other constraints prevent use of fiducial markers 1102(2) and 1102(3), but allow a central fiducial marker 1102(5), fiducial marker 1102(5) may not be visible to cameras 218(1) and 218(2) because trailer 106(1) blocks the corresponding view from cameras 218(1) and 218(2). However, camera 218(3), positioned on extendable mast 1220, has an unobstructed view of fiducial marker 1102(5), and images captured, at intervals or substantially continuously, by camera 218(3) may be used to provide a local frame of reference for tractor 104 that allows alignment module 260 to more accurately estimate a location and orientation of tractor 104. Alignment module 260 processes images from cameras 218, identifies fiducial markings 1102, and computes, based upon position and orientation of cameras 218 relative to tractor 104 and known locations of fiducial markings 1102, improved position and orientation of tractor 104. Accordingly, the position of trailer 106(1), which is determined based upon its length and angle relative to tractor 104, is also determined more accurately. Alignment module 260 may also use position and orientation determined by location unit 216 when determining the localized position of tractor 104. Alignment module 260 may be invoked at intervals to maintain the localized position and orientation of tractor 104 relative to loading dock 632 over time to mitigate drift errors.

In certain embodiments, alignment module 260 processes images (e.g., image 1300) captured by cameras 218(1) and 218(2) as tractor 104 and trailer 106 approach loading dock 632(3), to identify the position of fiducial markings 1102 within the images. Alignment module 260 then determines a position and/or orientation of tractor 104 relative to known (e.g., previously surveyed) positions of fiducial markings 1102, based upon optical configuration and position and orientation of cameras 218 relative to tractor 104. Alignment module 260 thereby improves position and/or orientation accuracy of tractor 104, as compared to position and orientation determined by location unit 216 using inertial navigation systems and odometry that may suffer from drift, and from a GPS signal that may suffer from availability and canyon effect, etc.

In certain embodiments, native objects may be used in conjunction with, or alternatively to, the fiducial markings 1102. Native objects may include environmental objects detectable by the alignment module 260, such as painted lane markers (stripes), dock seals, markings on the walls, signs, etc.). In certain embodiments, alignment module 260 processes images (e.g., image 1300) captured by cameras 218(1) and 218(2) as tractor 104 and trailer 106 approach loading dock 632(3), to identify the position of these native objects within the images. In FIG. 12, the edge 1210 of the dock may be a dock seal. The alignment module 260 then determines a position and/or orientation of tractor 104 and trailer 106 by comparing edge 1212 of the trailer 106 relative to the known (e.g., previously surveyed) positions of native object 1210, and based upon optical configuration and position and orientation of cameras 218 relative to tractor 104. Alignment module 260 thereby improves position and/or orientation accuracy of tractor 104, as compared to position and orientation determined by location unit 216 using inertial navigation systems and odometry that may suffer from drift, and from a GPS signal that may suffer from availability and canyon effect, etc.

### LIDAR “Fiducial” Positioning

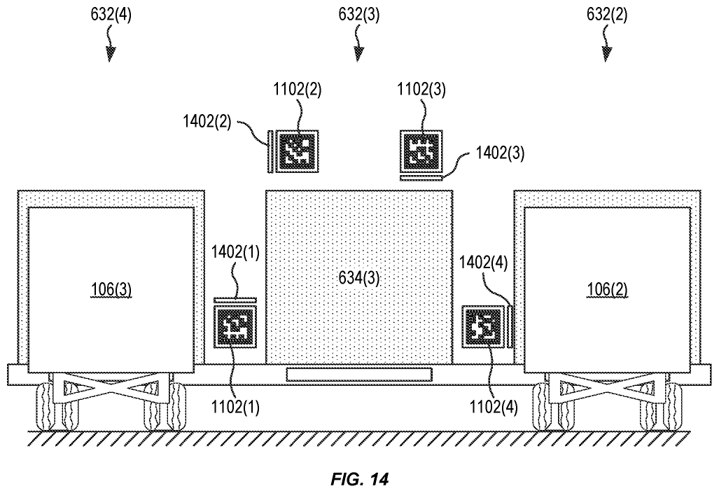

FIG. 14 is a front view of a loading dock 632(3) with two LIDAR poles 1402(1) and 1402(2) positioned adjacent a loading door 634(2). LIDAR poles 1402(1) and 1402(2) are thin straight poles that may be attached (e.g., at each end, clipped, etc.) adjacent to loading door 634(3) of loading dock 632(3), as shown in FIG. 14. LIDAR poles 1402 are of known dimensions, and have known positions (e.g., based on a survey). LIDAR poles 1402 may be mounted vertically or horizontally, as shown in FIG. 14, or may be mounted at other angles (e.g., diagonally, crossed, etc.) and/or in other positions without departing from the scope hereof.

In certain embodiments, an additional rear facing LIDAR 220(3) is positioned on extendable mast 1220 and lifted above tractor 104 to have a view of loading dock 632 as tractor 104 reverses trailer 106 into loading dock 632. LIDAR 220(3) captures point cloud 221 to include LIDAR poles 1402. In this embodiment, alignment module 260 processes point cloud 221 and identifies at least one LIDAR pole 1402 therein. Since LIDAR poles 1402 are structural elements that are easily distinguishable from background structure in point cloud 221, alignment module 260 may determines an accurate location of each LIDAR pole 1402 relative to tractor 104, and thereby determine an accurate position and orientation of tractor 104 relative to loading dock 632(3) based on known locations of LIDAR poles 1402 and position and orientation of LIDAR 220(3) relative to tractor 104.

Advantageously, by detecting LIDAR poles 1402 in point cloud 221, alignment module 260 improves position and/or orientation accuracy of tractor 104, as compared to position and orientation determined by location unit 216 using inertial navigation systems and odometry that may suffer from drift, and from a GPS signal that may suffer from availability and canyon effect, etc.

In certain embodiments, as shown in FIG. 14, LIDAR poles 1402 and fiducial markings 1102 may be positioned at loading dock 632(3), whereby alignment module 260 uses both images of fiducial marking 1102 captured by cameras 218 and point cloud 221 including LIDAR pole 1402 captured by LIDAR 220 to improve position and/or orientation accuracy of tractor 104. Further, alignment module 260 may selectively use one or both of fiducial marking 1102 and/or LIDAR pole 1402 based on current operating conditions (e.g., weather, lighting, time of day, etc.) that may favor a particular solution. Also, alignment module 260 may use fiducial marking 1102 captured by cameras 218 to accurately estimate a translational component of movement of tractor 104 and may use LIDAR pole 1402 and plane fit of point cloud 221 to accurately estimate a rotation component of movement of tractor 104. Advantageously, by using both fiducial markings 1102 and LIDAR poles 1402, alignment module 260 further improves accuracy of position and orientation of tractor 104.

Location unit 216 may provide a coordinate location (e.g., latitude and longitude when using GPS) of tractor 104 relative to a reference grid, and where infrastructure at autonomous yard 100 is surveyed and referenced to the same grid. Accordingly, the location and orientation accuracy of tractor 104 relative to loading dock 632(3) relies upon (a) the surveying accuracy of the infrastructure at autonomous yard 100, and (b) the accuracy of the GPS determined location and orientation of tractor 104. Advantageously, fiducial markings 1102 and/or LIDAR poles 1402 provide localized references that are independent of GPS. When one or more of cameras 218 and/or LIDAR 220 capture a corresponding fiducial marking 1102 or LIDAR pole 1402, alignment module 260 processes the corresponding images and/or point cloud 221 to infer a position and orientation of tractor 104 relative to the surveyed position of fiducial marking 1102 and/or LIDAR pole 1402. This inferred position and orientation may be used with the GPS determined location and orientation, or may be used to provide a location and orientation of tractor 104 independent of GPS. In certain embodiments, the inferred position and orientation may operate as a safeguard against GPS errors and/or surveying errors.

### Improved Trailer Position

Further, where tractor 104 includes extendable mast 1220 and one or both of camera 218(3) and LIDAR 220(3) mounted to extendable mast 1220, alignment module 260 may also identify trailer 106 (e.g., a back end or sides) within the images and/or point cloud 221, and thereby determine (a) an improved trailer angle 233 of trailer 106 relative to tractor 104 (see co-filed application titled “Systems and Methods for Determining an Articulated Trailer Angle”), and (b) a position and orientation of at least a back end of trailer 106 with reference to fiducial markings 1102 and/or LIDAR poles 1402. That is, alignment module 260 may determine improved location and orientation of both tractor 104 and trailer 106 by processing one or both of captured images and/or point cloud 221 that include fiducial markings 1102 and/or LIDAR poles 1402 and based on known locations of fiducial markings 1102 and/or LIDAR poles 1402.

Conventionally, the location of the back end of trailer 106 is estimated based on trailer angle 233 and a current location and orientation of tractor 104. Advantageously, by determining the location of the back end of trailer 106 relative to loading dock 632, tractor 104 may more accurately position trailer 106 at loading dock 632.

In certain embodiments, alignment module 260 may also, or alternatively, determine position adjustments for the back end of trailer 106 by determining a lateral difference between a center line of the back end of trailer 106 and the center line of loading dock 632 based on difference in position of the back end of trailer 106 and fiducial markings 1102 within images captured by cameras 218(1), 218(2), and/or 218(3). For example, based upon the known locations of fiducial markings 1102 relative to the center line of loading dock 632, and the position of the back end of trailer 106 and fiducial markings 1102 detected within images (e.g., image 1300, FIG. 13) captured by cameras 218, alignment module 260 may estimate deviation of trailer 106 from the center line of loading dock 632. This deviation may be input to maneuvering module 240 to allow tractor 104 to correct the deviation. Similarly, where the location of LIDAR poles 1402 are known relative to the center line of loading dock 632, alignment module 260 may estimate deviation of trailer 106 from the center line of loading dock 632 by determining distances between detected portions of trailer 106 and detected LIDAR poles 1402.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combination of Features

Features described above as well as those claimed below may be combined in various ways without departing from the scope hereof. The following enumerated examples illustrate some possible, non-limiting combinations:

(A1) A method for positioning and aligning an autonomous tractor in preparation for the tractor to couple with an articulated trailer located in a pick-up spot includes: determining a current location and orientation of the tractor; determining, based on the current location and a location of the pick-up spot, a staging path that terminates at a staging point corresponding to the pick-up spot; and controlling the tractor to follow the staging path to the staging point.

(A2) The embodiment (A1) further including determining a drive-by path corresponding to the pick-up spot; controlling the tractor to follow the drive-by path and reverse back to the staging point; capturing data corresponding to the pick-up spot while the tractor follows the drive-by path; and processing the data to detect presence of the trailer within the pick-up spot.

(A3) In either of embodiments (A1) or (A2), the capturing data including capturing at least two images of the pick-up spot using a camera mounted on the tractor, and the processing the data comprising processing the at least two images in stereo to detect the presence of the trailer.

(A4) In any of embodiments (A1)-(A3), the capturing data including capturing a point cloud of the pick-up spot using LIDAR mounted on the tractor, and the processing the data including processing the point cloud to detect the presence of the trailer.

(A5) Any of embodiments (A1)-(A4) further including requesting assistance from a remote operator when the presence of the trailer is not detected.

(A6) Any of embodiments (A1)-(A5) further including performing a maneuver from the staging point to position the tractor on a reference path, laterally aligned with a front center of the pick-up spot, and facing away from the trailer; and reversing the tractor straight backwards along the reference path.

(A7) Any of embodiments (A1)-(A6) further including performing a hitch function to hitch the tractor to the trailer.

(A8) Any of embodiments (A1)-(A7) further including receiving a loading dock status signal associated with the pick-up spot, wherein the loading dock status signal indicates readiness of the loading dock for the tractor to couple with the trailer.

(A9) Any of embodiments (A1)-(A8) further including capturing a trailer identifier from the trailer within the pick-up spot using a trailer ID capture device mounted on the tractor; and determining that the trailer identifier indicates the trailer is an expected trailer.

(B1) A method for positioning and aligning an autonomous tractor coupled to an articulated trailer in preparation for the tractor to reverse the trailer into a drop-off spot includes: determining a current location and a current orientation of the tractor and the trailer; determining, based on the current location, a staging path having a shape and a staging point at an end of the staging path; controlling the tractor to follow the staging path to the staging point; and wherein the staging path is shaped such that, after following the staging path to the staging point, the tractor and trailer are positioned for reversing into the drop-off spot.

(B2) The embodiment (B1) further including determining a backing path from the staging point into the drop-off spot; and controlling the tractor to reverse the trailer along the backing path into the drop-off spot.

(B3) Either of embodiments (B1) or (B2) further including determining a current location of the trailer based on the current location and the current orientation of the tractor, a length of the trailer, and a trailer angle indicative of an angle between the tractor and the trailer.

(B4) Any of embodiments (B1)-(B3) further including receiving a loading dock status signal associated with the drop-off spot, wherein the loading dock status signal indicates readiness of the loading dock to receive the trailer.

(B5) Any of embodiments (B1)-(B4) further including detecting that a current location of the trailer relative to the backing path exceeds a predefined tolerance and invoking a retry including: controlling the tractor to pull forward along reference path of the drop-off spot; and controlling the tractor to reverse the trailer along the reference path into the drop-off spot.

(B6) In any of embodiments (B1)-(B5), the determining the staging path including determining that the current location is within a near-side area of a maneuvering loop being followed by the tractor; and generating the staging path based on four points P1, P2, P3, and P4 that are located relative to the drop-off spot, wherein point P4 is at the end of the staging path and is located a stage lateral distance from a center of a front end of the drop-off spot and points P3 and P4 are a stage longitudinal distance from the front end of the drop-off spot, and points P1 and P2 are at locations that are the stage longitudinal distance plus a punch-out distance from the front end of the drop-off spot.

(B7) In any of embodiments (B1)-(B6), the determining the staging path including determining that the current location is within a far-side area of a maneuvering loop being followed by the tractor; and generating the staging path based on four points P5-P8 that are located relative to the drop-off spot, wherein point P8 is at the end of the staging path and is located a stage lateral distance from a center of a front end of the drop-off spot and points P7 and P8 are a stage longitudinal distance from the front end of the drop-off spot, and points P5 and P6 are at locations that are the stage longitudinal distance minus a punch-out distance from the front end of the drop-off spot.

(B8) In any of embodiments (B1)-(B7), the determining the staging path including determining that the current location is within a near-side area of a maneuvering loop being followed by the tractor; and generating, using a smooth curve generator, the staging path as a continuous curve between the current location and a point P9 that is at the end of the staging path, wherein a first tangent of the staging path at the current location and a second tangent of the staging path at point P9 are substantially parallel with a front end of the drop-off spot, and wherein the point P9 is located a stage lateral distance from a center of the front end of the drop-off spot and a stage longitudinal distance from the front end of the drop-off spot.

(B9) In any of embodiments (B1)-(B8), the determining the staging path including determining that the current location is within a far-side area of a maneuvering loop being followed by the tractor; and generating, using a smooth curve generator, the staging path as a continuous curve between the current location and a point P10 that is at the end of the staging path, wherein a first tangent of the staging path at the current location and a second tangent of the staging path at point P10 are substantially parallel with a front end of the drop-off spot, and wherein the point P10 is located a stage lateral distance from a center of the front end of the drop-off spot and a stage longitudinal distance from the front end of the drop-off spot.

(B10) Any of embodiments (B1)-(B9) further including capturing, using a LIDAR mounted to the tractor, a point cloud corresponding to the drop-off spot; processing the point cloud to detect any obstacles within the drop-off spot; and stopping the tractor when one or more objects are detected.

(B11) Any of embodiments (B1)-(B10) further including determining, at the staging point, that a trailer angle, indicative of an angle between the tractor and the trailer, is not within a predefined tolerance of being zero; controlling the tractor to move forward in a straight line for a predefined distance; and controlling the tractor to move straight backward to the staging point.

(B12) Any of embodiments (B1)-(B11) further including capturing, using at least one camera attached to the tractor, at least one image of at least one fiducial marking positioned at a known location relative to the drop-off spot; and determining an improved current location and/or current orientation of the tractor based on a location of the at least one fiducial marking within the at least one image.

(B13) Any of embodiments (B1)-(B12) further including capturing, using at least one LIDAR attached to the tractor, a point cloud including at least one fiducial marking positioned at a known location relative to the drop-off spot, wherein the at least one fiducial marking is a LIDAR pole; and determining an improved current location and/or current orientation of the tractor based on a location of the at least one fiducial marking within the point cloud.

What is claimed is:

1. A method for positioning and aligning an autonomous tractor in preparation for the tractor to couple with an articulated trailer located in a pick-up spot, the method comprising:
determining a current location and orientation of the tractor;
determining, based on the current location and a location of the pick-up spot, a staging path that terminates at a staging point corresponding to the pick-up spot; and
controlling the tractor to follow the staging path to the staging point.

2. The method of claim 1, further comprising:
determining a drive-by path corresponding to the pick-up spot;
controlling the tractor to follow the drive-by path and reverse back to the staging point;
capturing data corresponding to the pick-up spot while the tractor follows the drive-by path; and
processing the data to detect presence of the trailer within the pick-up spot.

3. The method of claim 2, the capturing data comprising capturing at least two images of the pick-up spot using a camera mounted on the tractor, and the processing the data comprising processing the at least two images in stereo to detect the presence of the trailer.

4. The method of claim 2, the capturing data comprising capturing a point cloud of the pick-up spot using LIDAR mounted on the tractor, and the processing the data comprising processing the point cloud to detect the presence of the trailer.

5. The method of claim 2, further comprising requesting assistance from a remote operator when the presence of the trailer is not detected.

6. The method of claim 1, further comprising:
performing a maneuver from the staging point to position the tractor on a reference path, laterally aligned with a front center of the pick-up spot, and facing away from the trailer; and
reversing the tractor straight backwards along the reference path.

7. The method of claim 6, further comprising performing a hitch function to hitch the tractor to the trailer.

8. The method of claim 1, further comprising receiving a loading dock status signal associated with the pick-up spot, wherein the loading dock status signal indicates readiness of the loading dock for the tractor to couple with the trailer.

9. The method of claim 1, further comprising:
capturing a trailer identifier from the trailer within the pick-up spot using a trailer ID capture device mounted on the tractor; and
determining that the trailer identifier indicates the trailer is an expected trailer.

10. A method for positioning and aligning an autonomous tractor coupled to an articulated trailer in preparation for the tractor to reverse the trailer into a drop-off spot, comprising:
determining a current location and a current orientation of the tractor and the trailer;
determining, based on the current location, a staging path having a shape and a staging point at an end of the staging path;
controlling the tractor to follow the staging path to the staging point; and
wherein the staging path is shaped such that, after following the staging path to the staging point, the tractor and trailer are positioned for reversing into the drop-off spot.

11. The method of claim 10, further comprising:
determining a backing path from the staging point into the drop-off spot; and
controlling the tractor to reverse the trailer along the backing path into the drop-off spot.

12. The method of claim 11, further comprising determining a current location of the trailer based on the current location and the current orientation of the tractor, a length of the trailer, and a trailer angle indicative of an angle between the tractor and the trailer.

13. The method of claim 10, further comprising receiving a loading dock status signal associated with the drop-off spot, wherein the loading dock status signal indicates readiness of the loading dock to receive the trailer.

14. The method of claim 11, further comprising detecting that a current location of the trailer relative to the backing path exceeds a predefined tolerance and invoking a retry including:
controlling the tractor to pull forward along reference path of the drop-off spot; and
controlling the tractor to reverse the trailer along the reference path into the drop-off spot.

15. The method of claim 10, the determining the staging path comprising:
determining that the current location is within a near-side area of a maneuvering loop being followed by the tractor; and
generating the staging path based on four points P1, P2, P3, and P4 that are located relative to the drop-off spot, wherein point P4 is at the end of the staging path and is located a stage lateral distance from a center of a front end of the drop-off spot and points P3 and P4 are a stage longitudinal distance from the front end of the drop-off spot, and points P1 and P2 are at locations that are the stage longitudinal distance plus a punch-out distance from the front end of the drop-off spot.

16. The method of claim 10, the determining the staging path comprising:
determining that the current location is within a far-side area of a maneuvering loop being followed by the tractor; and
generating the staging path based on four points P5-P8 that are located relative to the drop-off spot, wherein point P8 is at the end of the staging path and is located a stage lateral distance from a center of a front end of the drop-off spot and points P7 and P8 are a stage longitudinal distance from the front end of the drop-off spot, and points P5 and P6 are at locations that are the stage longitudinal distance minus a punch-out distance from the front end of the drop-off spot.

17. The method of claim 10, the determining the staging path comprising:
determining that the current location is within a near-side area of a maneuvering loop being followed by the tractor; and
generating, using a smooth curve generator, the staging path as a continuous curve between the current location and a point P9 that is at the end of the staging path, wherein a first tangent of the staging path at the current location and a second tangent of the staging path at point P9 are substantially parallel with a front end of the drop-off spot, and wherein the point P9 is located a stage lateral distance from a center of the front end of the drop-off spot and a stage longitudinal distance from the front end of the drop-off spot.

18. The method of claim 10, the determining the staging path comprising:
determining that the current location is within a far-side area of a maneuvering loop being followed by the tractor; and
generating, using a smooth curve generator, the staging path as a continuous curve between the current location and a point P10 that is at the end of the staging path, wherein a first tangent of the staging path at the current location and a second tangent of the staging path at point P10 are substantially parallel with a front end of the drop-off spot, and wherein the point P10 is located a stage lateral distance from a center of the front end of the drop-off spot and a stage longitudinal distance from the front end of the drop-off spot.

19. The method of claim 10, further comprising:
capturing, using a LIDAR mounted to the tractor, a point cloud corresponding to the drop-off spot;
processing the point cloud to detect any obstacles within the drop-off spot; and
stopping the tractor when one or more objects are detected.

20. The method of claim 10, further comprising:
determining, at the staging point, that a trailer angle, indicative of an angle between the tractor and the trailer, is not within a predefined tolerance of being zero;
controlling the tractor to move forward in a straight line for a predefined distance; and
controlling the tractor to move straight backward to the staging point.

21. The method of claim 10, further comprising:
capturing, using at least one camera attached to the tractor, at least one image of at least one fiducial marking positioned at a known location relative to the drop-off spot; and
determining an improved current location and/or current orientation of the tractor based on a location of the at least one fiducial marking within the at least one image.

22. The method of claim 10, further comprising:
capturing, using at least one LIDAR attached to the tractor, a point cloud including at least one fiducial marking positioned at a known location relative to the drop-off spot, wherein the at least one fiducial marking is a LIDAR pole; and
determining an improved current location and/or current orientation of the tractor based on a location of the at least one fiducial marking within the point cloud.
